(19) United States
(12) Patent Application Publication
(10) Pub. No.: US 2017/0237801 A1
(43) Pub. Date: Aug. 17, 2017

(54) DEVICE CONFIGURATION-BASED FUNCTION DELIVERY

(71) Applicant: Google Inc., Mountain View, CA (US)

(72) Inventors: Shumeet Baluja, Leesburg, VA (US); Gaurav Bhaya, Sunnyvale, CA (US); Robert Stets, Mountain View, CA (US)

(73) Assignee: Google Inc., Mountain View, CA (US)

(21) Appl. No.: 15/587,132

(22) Filed: May 4, 2017

Related U.S. Application Data
(63) Continuation-in-part of application No. 15/189,826, filed on Jun. 22, 2016.
Application No. 15/189,826 is a continuation of application No. 10/880,868, filed on Jun. 30, 2004, now abandoned.
Application No. 10/880,868 is a continuation-in-part of application No. 15/395,703, filed on Dec. 30, 2016.

(51) Int. Cl. H04L 29/08; G10L 15/22; G10L 15/30; G10L 15/18

(52) U.S. Cl. CPC H04L 67/04; G10L 15/1822; G10L 15/22; G10L 15/30; H04L 67/42

(57) ABSTRACT

The present disclosure is directed to a system for device configuration-based function delivery. A server receives a data structure including device configuration information that indicates the computing device comprises an application programming interface to allow a data function to access a call function of the computing device. The server identifies a first content item having a call-on-select function and a second content item without a call-on-select function. The server determines, based on the device configuration information, a first call score for the first content item having the call-on-select function and a second call score for the second content item without the call-on-select function. The server selects the second content item for transmission to the computing device to cause the computing device to display the second content item without the call-on-select function on the computing device comprising the application programming interface.

### CROSS-REFERENCE TO RELATED APPLICATIONS

This application claims the benefit of priority under 35 U.S.C. §120 as a continuation-in-part of U.S. patent Ser. No. 15/189,826, filed Jun. 22, 2016, which claims the benefit of priority under 35 U.S.C. §120 as a continuation of U.S. patent application Ser. No. 10/880,868, filed Jun. 30, 2004. This application also claims the benefit of priority under 35 U.S.C. §120 as a continuation-in-part of U.S. patent Ser. No. 15/395,703, filed on Dec. 30, 2016. Each of the foregoing applications are hereby incorporated herein by reference in their entirety.

### FIELD OF THE DISCLOSURE

The present disclosure concerns electronic content items, such as those served in an online environment. In particular, the present disclosure concerns adapting an online electronic document environment to make content items more useful for devices with call functionality, and/or a limited ability to render Web pages in a manner satisfying to a user (e.g., due to small displays, slow communications connection speeds, and/or slow rendering), such as mobile phones for example.

### BACKGROUND INFORMATION

Content items can be provided for display on computing devices using the Internet. They can be selected responsive to a search query input in a search engine, or based on a document requested by the computing device. Content items, which can also be referred to as digital components or abbreviated as CI, can be displayed in association with an online document, such as a search results page, or a Webpage with content for example. Online content items can include embedded information (e.g., links) such that when the content item is selected (e.g., by a user clicking on the content item), a browser is loaded with a document (e.g., a Webpage) associated with the content item. Such a document can be referred to as the “landing page” of the content item.

Although using Web pages, such as those authored in HTML or some other markup language for example, as content item landing pages is useful when the user is using a browser on a device with an adequate display monitor (e.g., 13″, 15″, 17″, 19″, 21″, etc., or perhaps even smaller), the use of the same Web pages as content item landing pages is much less useful when the user is using a device with a smaller and/or lower resolution display. Similarly, although using Web pages as content item landing pages is useful when the user device has an adequate communications connection to the Internet (e.g., a 56 Kbps modem, a higher speed digital subscriber line (DSL) modem, or a higher speed cable modem) and an adequate processor for rendering the Web page, using Web pages as content item landing pages is much less useful when the user device has a slow communications connection (e.g., 9.6 Kbps) and/or a slow processor.

### SUMMARY OF THE DISCLOSURE

According to one aspect of the disclosure, a system for device configuration-based function delivery includes a server that includes one or more processors and a memory. The server can receive, from a first computing device via a network, a data structure that can include device configuration information. The server can identify, responsive to a request from the first computing device that accessed an online resource having content, a first digital component and a second digital component. The first digital component can have a command corresponding to a type of function. The second digital component cannot have the command corresponding to the type of function. The server can determine, based on the content of the online resource accessed by the first computing device, a first document score for the first digital component and a second document score for the second digital component. The second document score can be greater than the first document score. The server can determine, based on the device configuration information that indicates the type of function of the first computing device, a first function score for the first digital component having the command and a second function score for the second digital component item without the command. The second function score can be less than the first function score. The server can combine the first document score with the first function score to generate a first overall score for the first digital component. The server can combine the second document score with the second function score to generate a second overall score for the second digital component. The second overall score can be less than the first overall score. The server can select, based on the first overall score being greater than the second overall score, the first digital component with the command corresponding to the type of function for transmission. The server can transmit, to a second computing device based on the device configuration information indicating the first computing device does not have the type of function, the first digital component.

According to another aspect of the disclosure a configuration-based function delivery method can include receiving, from a first computing device via a network, a data structure including device configuration information. The method can include identifying, responsive to a request from the first computing device that accessed an online resource having content, a first digital component and a second digital component. The first digital component can have a command corresponding to a type of function and the second digital component cannot have the command corresponding to the type of function. The method can include determining, based on the content of the online resource accessed by the first computing device, a first document score for the first digital component and a second document score for the second digital component. The second document score can be greater than the first document score. The method can include determining, based on the device configuration information that indicates the type of function of the first computing device, a first function score for the first digital component having the command and a second function score for the second digital component item without the command. The second function score can be less than the first function score. The method can include combining the first document score with the first function score to generate a first overall score for the first digital component. The method can include combining the second document score with the second function score to generate a second overall score for the second digital component, the second overall score less than the first overall score. The method can include selecting, based on the first overall score being greater than the second overall score, the first digital component with the command corresponding to the type of function for transmission. The method can include transmitting, to a second computing device based on the device configuration information indicating the first computing device does not have the type of function, the first digital component.

### BRIEF DESCRIPTION OF THE DRAWINGS

FIG. 1A is a high-level diagram showing parties or entities that can interact with a system.

FIG. 1B depicts a system to of multi-modal transmission of packetized data in a voice activated computer network environment.

FIG. 1C depicts a flow diagram for multi-modal transmission of packetized data in a voice activated computer network environment.

FIG. 2 is a diagram illustrating an environment in which, or with which, the present invention may operate.

FIG. 3 is a Venn diagram illustrating a classification of user devices consistent with the present invention.

FIGS. 4 and 5 are diagrams of a mobile telephone with which with the present invention may be used.

FIG. 6 illustrates an exemplary data structure for storing a request message in a manner consistent with the present invention.

FIG. 7 is a flow diagram of an exemplary method for performing serve operations in a manner consistent with the present invention.

FIGS. 8-12 are exemplary displays consistent with the present invention.

FIG. 13A is a flow diagram of an exemplary method for performing user selection operations in a manner consistent with the present invention.

FIG. 13B depicts method of multi-modal transmission of packetized data in a voice activated computer network environment.

FIG. 13C illustrates a block diagram of an example method for configuration-based function delivery.

FIG. 14 is a block diagram of an exemplary apparatus that may perform various operations in a manner consistent with the present invention.

### DETAILED DESCRIPTION

Following below are more detailed descriptions of various concepts related to, and implementations of, methods, apparatuses, and systems for multi-modal transmission of packetized data in a voice activated data packet based computer network environment. The various concepts introduced above and discussed in greater detail below may be implemented in any of numerous ways.

Systems and methods of the present disclosure relate generally to a data processing system that identifies an optimal transmission modality for data packet (or other protocol based) transmission in a voice activated computer network environment. The data processing system can improve the efficiency and effectiveness of data packet transmission over one or more computer networks by, for example, selecting a transmission modality from a plurality of options for data packet routing through a computer network of content items to one or more client computing device, or to different interfaces (e.g., different apps or programs) of a single client computing device. Data packets or other protocol based signals corresponding to the selected operations can be routed through a computer network between multiple computing devices. For example the data processing system can route a content item to a different interface than an interface from which a request was received. The different interface can be on the same client computing device or a different client computing device from which a request was received. The data processing system can select at least one candidate interface from a plurality of candidate interfaces for content item transmission to a client computing device. The candidate interfaces can be determined based on technical or computing parameters such as processor capability or utilization rate, memory capability or availability, battery status, available power, network bandwidth utilization, interface parameters or other resource utilization values. By selecting an interface to receive and provide the content item for rendering from the client computing device based on candidate interfaces or utilization rates associated with the candidate interfaces, the data processing system can reduce network bandwidth usage, latency, as well as processing utilization and power consumption of the client computing device that renders the content item. This saves processing power and other computing resources such as memory, reduces electrical power consumption by the data processing system and the reduced data transmissions via the computer network reduces bandwidth requirements and usage of the data processing system.

The systems and methods described herein can include a data processing system that receives an input audio query, which can also be referred to as an input audio signal. From the input audio query the data processing system can identify a request and a trigger keyword corresponding to the request. Based on the trigger keyword or the request, the data processing system can generate a first action data structure. For example, the first action data structure can include an organic response to the input audio query received from a client computing device, and the data processing system can provide the first action data structure to the same client computing device for rendering as audio output via the same interface from which the request was received.

The data processing system can also select at least one content item based on the trigger keyword or the request. The content items can also be referred to as digital components. In some implementations, the digital component is a component of the content item. In other implementations, the content item is a component of the digital component. The data processing system can identify or determine a plurality of candidate interfaces for rendering of the content item(s). The interfaces can include one or more hardware or software interfaces, such as display screens, audio interfaces, speakers, applications or programs available on the client computing device that originated the input audio query, or on different client computing devices. The interfaces can include java script slots for online documents for the insertion of content items, as well as push notification interfaces. The data processing system can determine utilization values for the different candidate interfaces. The utilization values can indicate power, processing, memory, bandwidth, or interface parameter capabilities, for example. Based on the utilization values for the candidate interfaces the data processing system can select a candidate interface as a selected interface for presentation or rendering of the content item. For example, the data processing system can convert or provide the content item for delivery in a modality compatible with the selected interface. The selected interface can be an interface of the same client computing device that originated the input audio signal or a different client computing device. By routing data packets via a computing network based on utilization values associated with a candidate interface, the data processing system selects a destination for the content item in a manner that can use the least amount of processing power, memory, or bandwidth from available options, or that can conserve power of one or more client computing devices.

The data processing system can provide the content item or the first action data structure by packet or other protocol based data message transmission via a computer network to a client computing device. The output signal can cause an audio driver component of the client computing device to generate an acoustic wave, e.g., an audio output, which can be output from the client computing device. The audio (or other) output can correspond to the first action data structure or to the content item. For example the first action data structure can be routed as audio output, and the content item can be routed as a text based message. By routing the first action data structure and the content item to different interfaces, the data processing system can conserve resources utilized by each interface, relative to providing both the first action data structure and the content item to the same interface. This results in fewer data processing operations, less memory usage, or less network bandwidth utilization by the selected interfaces (or their corresponding devices) than would be the case without separation and independent routing of the first action data structure and the content item.

The present invention may involve novel methods, apparatus, message formats, and/or data structures for considering device type information such as display size and/or resolution, communications connection speed, processor speed, and/or call functionality for example, in an on-line environment. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventor regards his invention as any patentable subject matter described.

### Environments in which, or with which, Embodiments Consistent with the Present Invention May Operate

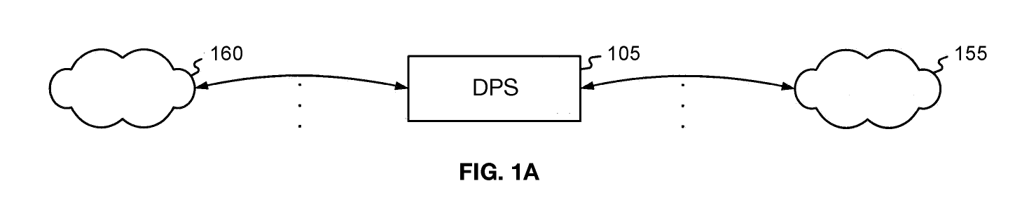

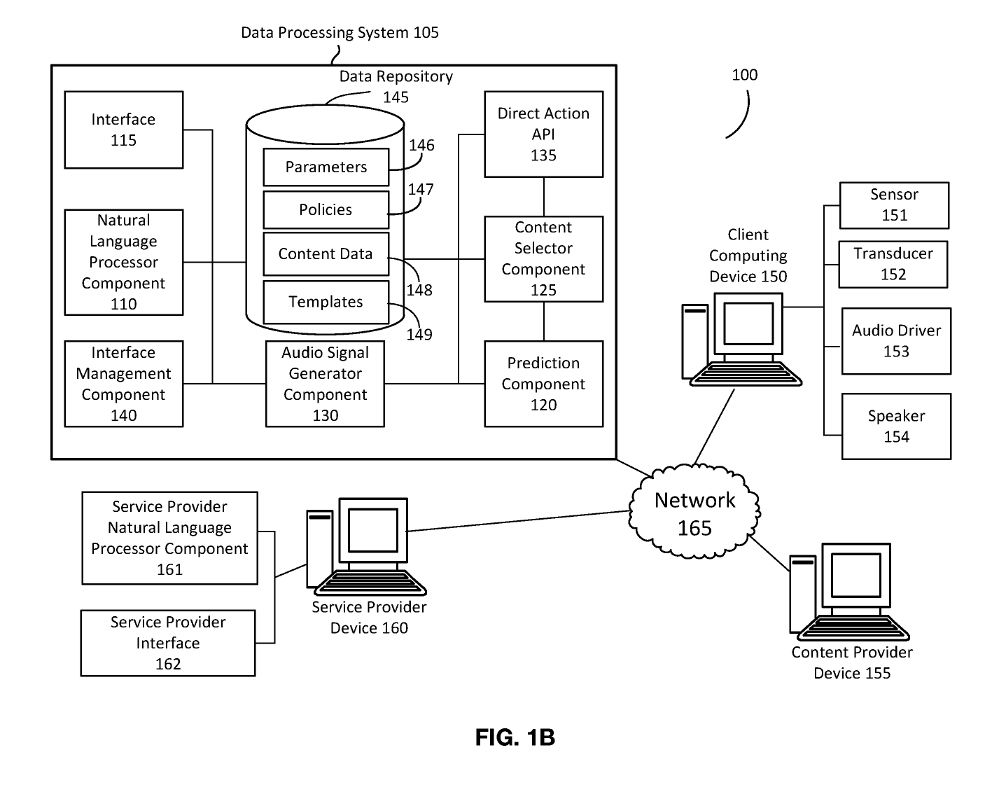

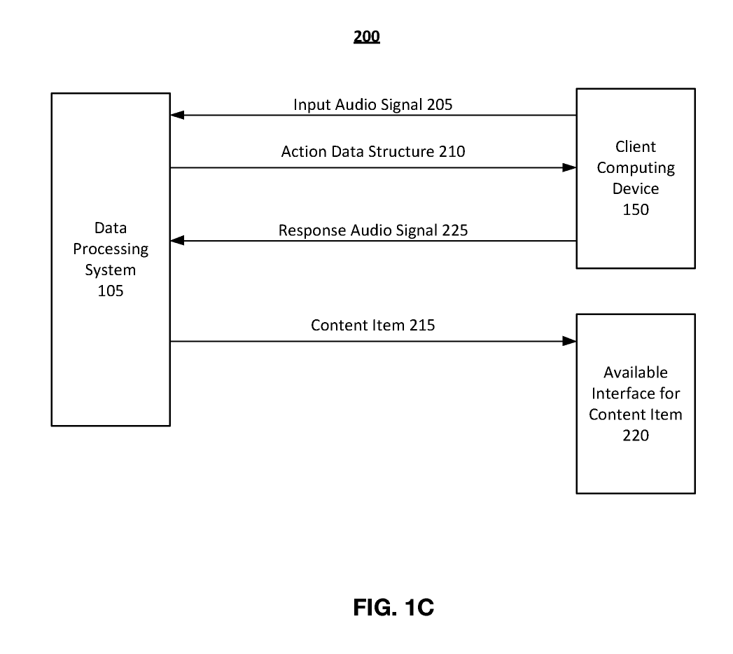

FIG. 1A is a high level diagram of an environment. The environment may include a digital component entry, maintenance and delivery system (simply referred to as data processing system) 120. Service providers 160 may directly, or indirectly, enter, maintain, and track digital component information in the data processing system (DPS) 105. The digital components may be in the form of graphical digital components such as so-called banner ads, text only ads, image ads, audio ads, video ads, digital components combining one of more of any of such components, etc. The digital components may also include embedded information, such as a link, and/or machine executable instructions. A content provider 155 may submit requests for digital components to, accept digital components responsive to their request from, and provide usage information to, the data processing system 105. An entity other than a content provider 155 may initiate a request for ads. Although not shown, other entities may provide usage information (e.g., whether or not a conversion or click-through related to the digital component occurred) to the data processing system 105. This usage information may include measured or observed user behavior related to digital components that have been served.

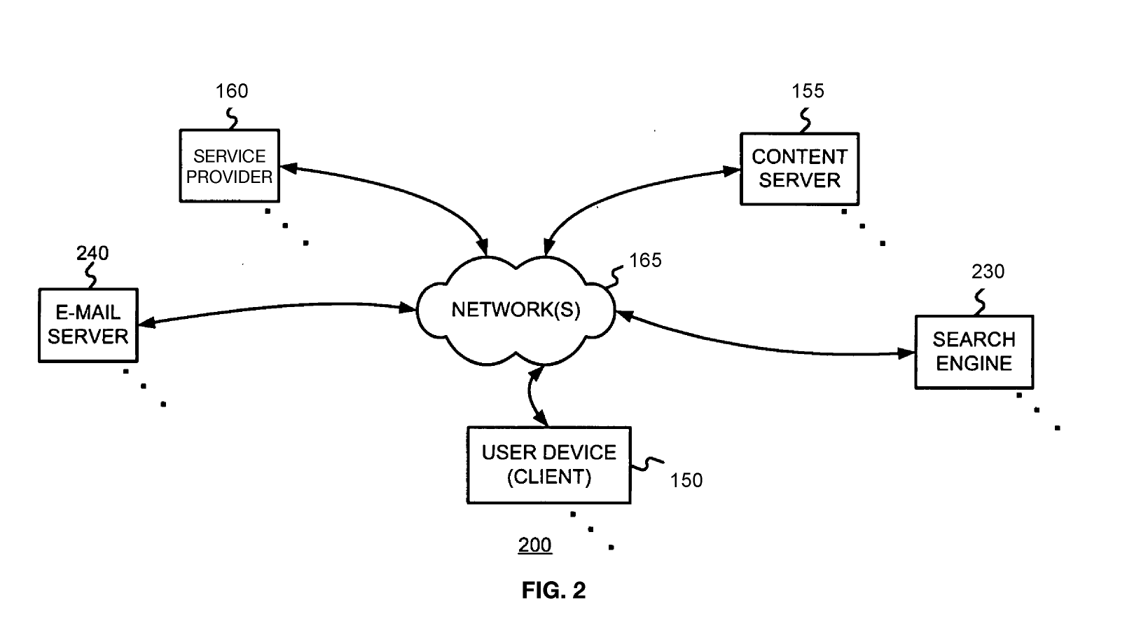

The data processing system 105 may be similar to the one described in FIG. 2 of the '900 application. A digital component program may include information concerning accounts, campaigns, creatives, targeting, etc. The term “account” relates to information for a given service provider (e.g., a unique e-mail address, a password, billing information, etc.). A “campaign” or “digital component campaign” refers to one or more groups of one or more digital components, and may include a start date, an end date, budget information, geo-targeting information, syndication information, etc. For example, Honda may have one digital component campaign for its automotive line, and a separate digital component campaign for its motorcycle line. The campaign for its automotive line may have one or more digital component groups, each containing one or more ads. Each digital component group may include targeting information (e.g., a set of keywords, a set of one or more topics, geolocation information, user profile information, user device characteristics, etc.), and price or offer information (e.g., maximum cost or cost per selection, maximum cost or cost per conversion, etc.)). Alternatively, or in addition, each digital component group may include an average cost (e.g., average cost per selection, average cost per conversion, etc.). Therefore, a single maximum cost and/or a single average cost may be associated with one or more keywords, and/or topics. As stated, each digital component group may have one or more digital components or “creatives” (That is, digital component content that is ultimately rendered to an end user.). Each digital component may also include a link to a URL (e.g., a landing Web page, such as the home page of a service provider, or a Web page associated with a particular product or server) and/or a telephone number. Naturally, the digital component information may include more or less information, and may be organized in a number of different ways. In at least some embodiments, the user device characteristics (or configurations) may include one or more of (i) whether or not the user device has call functionality, (ii) whether or not the user device is “limited”, (iii) whether or not the user device has a small display, (iv) whether or not the user device has a low resolution display, (v) whether or not the user device has a slow communications connection speed, (vi) whether or not the user device has a slow processor, (vii) whether or not the user device has a limited user input interface, etc.

FIG. 1B depicts an example system 100 to for multi-modal transmission of packetized data in a voice activated data packet (or other protocol) based computer network environment. The system 100 can include at least one data processing system 105. The data processing system 105 can include at least one server having at least one processor. For example, the data processing system 105 can include a plurality of servers located in at least one data center or server farm. The data processing system 105 can determine, from an audio input signal a request and a trigger keyword associated with the request. Based on the request and trigger keyword the data processing system 105 can determine or select at least one action data structure, and can select at least one content item (and initiate other actions as described herein). The data processing system 105 can identify candidate interfaces for rendering of the action data structures or the content items, and can provide the action data structures or the content items for rendering by one or more candidate interfaces on one or more client computing devices based on resource utilization values for or of the candidate interfaces, for example as part of a voice activated communication or planning system. The action data structures (or the content items) can include one or more audio files that when rendered provide an audio output or acoustic wave. The action data structures or the content items can include other content (e.g., text, video, or image content) in addition to audio content.

The data processing system 105 can include multiple, logically-grouped servers and facilitate distributed computing techniques. The logical group of servers may be referred to as a data center, server farm or a machine farm. The servers can be geographically dispersed. A data center or machine farm may be administered as a single entity, or the machine farm can include a plurality of machine farms. The servers within each machine farm can be heterogeneous—one or more of the servers or machines can operate according to one or more type of operating system platform. The data processing system 105 can include servers in a data center that are stored in one or more high-density rack systems, along with associated storage systems, located for example in an enterprise data center. The data processing system 105 with consolidated servers in this way can improve system manageability, data security, the physical security of the system, and system performance by locating servers and high performance storage systems on localized high performance networks. Centralization of all or some of the data processing system 105 components, including servers and storage systems, and coupling them with advanced system management tools allows more efficient use of server resources, which saves power and processing requirements and reduces bandwidth usage.

The data processing system 105 can include at least one natural language processor (NLP) component 110, at least one interface 115, at least one prediction component 120, at least one content selector component 125, at least one audio signal generator component 130, at least one direct action application programming interface (API) 135, at least one interface management component 140, and at least one data repository 145. The NLP component 110, interface 115, prediction component 120, content selector component 125, audio signal generator component 130, direct action API 135, and interface management component 140 can each include at least one processing unit, server, virtual server, circuit, engine, agent, appliance, or other logic device such as programmable logic arrays configured to communicate with the data repository 145 and with other computing devices (e.g., at least one client computing device 150, at least one content provider computing device 155, or at least one service provider computing device 160) via the at least one computer network 165. The network 165 can include computer networks such as the internet, local, wide, metro or other area networks, intranets, satellite networks, other computer networks such as voice or data mobile phone communication networks, and combinations thereof.

The network 165 can include or constitute a display network, e.g., a subset of information resources available on the internet that are associated with a content placement or search engine results system, or that are eligible to include third party content items as part of a content item placement campaign. The network 165 can be used by the data processing system 105 to access information resources such as web pages, web sites, domain names, or uniform resource locators that can be presented, output, rendered, or displayed by the client computing device 150. For example, via the network 165 a user of the client computing device 150 can access information or data provided by the data processing system 105, the content provider computing device 155 or the service provider computing device 160.

The network 165 can include, for example a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network or a wireline network, and combinations thereof. The network 165 can include a wireless link, such as an infrared channel or satellite band. The topology of the network 165 may include a bus, star, or ring network topology. The network 165 can include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”) or universal mobile telecommunications system (“UMTS”). Different types of data may be transmitted via different protocols, or the same types of data may be transmitted via different protocols.

The client computing device 150, the content provider computing device 155, and the service provider computing device 160 can each include at least one logic device such as a computing device having a processor to communicate with each other or with the data processing system 105 via the network 165. The client computing device 150, the content provider computing device 155, and the service provider computing device 160 can each include at least one server, processor or memory, or a plurality of computation resources or servers located in at least one data center. The client computing device 150, the content provider computing device 155, and the service provider computing device 160 can each include at least one computing device such as a desktop computer, laptop, tablet, personal digital assistant, smartphone, portable computer, server, thin client computer, virtual server, or other computing device.

The client computing device 150 can include at least one sensor 151, at least one transducer 152, at least one audio driver 153, and at least one speaker 154. The sensor 151 can include a microphone or audio input sensor. The transducer 152 can convert the audio input into an electronic signal, or vice-versa. The audio driver 153 can include a script or program executed by one or more processors of the client computing device 150 to control the sensor 151, the transducer 152 or the audio driver 153, among other components of the client computing device 150 to process audio input or provide audio output. The speaker 154 can transmit the audio output signal.

The client computing device 150 can be associated with an end user that enters voice queries as audio input into the client computing device 150 (via the sensor 151) and receives audio output in the form of a computer generated voice that can be provided from the data processing system 105 (or the content provider computing device 155 or the service provider computing device 160) to the client computing device 150, output from the speaker 154. The audio output can correspond to an action data structure received from the direct action API 135, or a content item selected by the content selector component 125. The computer generated voice can include recordings from a real person or computer generated language.

The content provider computing device 155 (or the data processing system 105 or service provider computing device 160) can provide audio based content items or action data structures for display by the client computing device 150 as an audio output. The action data structure or content item can include an organic response or offer for a good or service, such as a voice based message that states: “Today it will be sunny and 80 degrees at the beach” as an organic response to a voice-input query of “Is today a beach day?”. The data processing system 105 (or other system 100 component such as the content provider computing device 155 can also provide a content item as a response, such as a voice or text message based content item offering sunscreen.

The content provider computing device 155 or the data repository 145 can include memory to store a series of audio action data structures or content items that can be provided in response to a voice based query. The action data structures and content items can include packet based data structures for transmission via the network 165. The content provider computing device 155 can also provide audio or text based content items (or other content items) to the data processing system 105 where they can be stored in the data repository 145. The data processing system 105 can select the audio action data structures or text based content items and provide (or instruct the content provider computing device 155 to provide) them to the same or different client computing devices 150 responsive to a query received from one of those client computing device 150. The audio based action data structures can be exclusively audio or can be combined with text, image, or video data. The content items can be exclusively text or can be combined with audio, image or video data.

The service provider computing device 160 can include at least one service provider natural language processor (NLP) component 161 and at least one service provider interface 162. The service provider NLP component 161 (or other components such as a direct action API of the service provider computing device 160) can engage with the client computing device 150 (via the data processing system 105 or bypassing the data processing system 105) to create a back-and-forth real-time voice or audio based conversation (e.g., a session) between the client computing device 150 and the service provider computing device 160. For example, the service provider interface 162 can receive or provide data messages (e.g., action data structures or content items) to the direct action API 135 of the data processing system 105. The direct action API 135 can also generate the action data structures independent from or without input from the service provider computing device 160. The service provider computing device 160 and the content provider computing device 155 can be associated with the same entity. For example, the content provider computing device 155 can create, store, or make available content items for beach relates services, such as sunscreen, beach towels or bathing suits, and the service provider computing device 160 can establish a session with the client computing device 150 to respond to a voice input query about the weather at the beach, directions for a beach, or a recommendation for an area beach, and can provide these content items to the end user of the client computing device 150 via an interface of the same client computing device 150 from which the query was received, a different interface of the same client computing device 150, or an interface of a different client computing device. The data processing system 105, via the direct action API 135, the NLP component 110 or other components can also establish the session with the client computing device, including or bypassing the service provider computing device 160, to for example to provide an organic response to a query related to the beach.

The data repository 145 can include one or more local or distributed databases, and can include a database management system. The data repository 145 can include computer data storage or memory and can store one or more parameters 146, one or more policies 147, content data 148, or templates 149 among other data. The parameters 146, policies 147, and templates 149 can include information such as rules about a voice based session between the client computing device 150 and the data processing system 105 (or the service provider computing device 160). The content data 148 can include content items for audio output or associated metadata, as well as input audio messages that can be part of one or more communication sessions with the client computing device 150.

The system 100 can optimize processing of action data structures and content items in a voice activated data packet (or other protocol) environment. For example, the data processing system 105 can include or be part of a voice activated assistant service, voice command device, intelligent personal assistant, knowledge navigator, event planning, or other assistant program. The data processing system 105 can provide one or more instances of action data structures as audio output for display from the client computing device 150 to accomplish tasks related to an input audio signal. For example, the data processing system can communicate with the service provider computing device 160 or other third party computing devices to generate action data structures with information about a beach, among other things. For example, an end user can enter an input audio signal into the client computing device 150 of: “OK, I would like to go to the beach this weekend” and an action data structure can indicate the weekend weather forecast for area beaches, such as “it will be sunny and 80 degrees at the beach on Saturday, with high tide at 3 pm.”

The action data structures can include a number of organic or non-sponsored responses to the input audio signal. For example, the action data structures can include a beach weather forecast or directions to a beach. The action data structures in this example include organic or non-sponsored content that is directly responsive to the input audio signal. The content items responsive to the input audio signal can include sponsored or non-organic content, such as an offer to buy sunscreen from a convenience store located near the beach. In this example, the organic action data structure (beach forecast) is responsive to the input audio signal (a query related to the beach), and the content item (a reminder or offer for sunscreen) is also responsive to the same input audio signal. The data processing system 105 can evaluate system 100 parameters (e.g., power usage, available displays, formats of displays, memory requirements, bandwidth usage, power capacity or time of input power (e.g., internal battery or external power source such as a power source from a wall output) to provide the action data structure and the content item to different candidate interfaces on the same client computing device 150, or to different candidate interfaces on different client computing devices 150.

The data processing system 105 can include an application, script or program installed at the client computing device 150, such as an app to communicate input audio signals (e.g., as data packets via a packetized or other protocol based transmission) to at least one interface 115 of the data processing system 105 and to drive components of the client computing device 150 to render output audio signals (e.g., for action data structures) or other output signals (e.g., content items). The data processing system 105 can receive data packets or other signal that includes or identifies an audio input signal. For example, the data processing system 105 can execute or run the NLP component 110 to receive the audio input signal.

The NLP component 110 can convert the audio input signal into recognized text by comparing the input signal against a stored, representative set of audio waveforms (e.g., in the data repository 145) and choosing the closest matches. The representative waveforms are generated across a large set of users, and can be augmented with speech samples. After the audio signal is converted into recognized text, the NLP component 110 can match the text to words that are associated, for example via training across users or through manual specification, with actions that the data processing system 105 can serve.

The audio input signal can be detected by the sensor 151 (e.g., a microphone) of the client computing device. Via the transducer 152, the audio driver 153, or other components the client computing device 150 can provide the audio input signal to the data processing system 105 (e.g., via the network 165) where it can be received (e.g., by the interface 115) and provided to the NLP component 110 or stored in the data repository 145 as content data 148.

The NLP component 110 can receive or otherwise obtain the input audio signal. From the input audio signal, the NLP component 110 can identify at least one request or at least one trigger keyword corresponding to the request. The request can indicate intent or subject matter of the input audio signal. The trigger keyword can indicate a type of action likely to be taken. For example, the NLP component 110 can parse the input audio signal to identify at least one request to go to the beach for the weekend. The trigger keyword can include at least one word, phrase, root or partial word, or derivative indicating an action to be taken. For example, the trigger keyword “go” or “to go to” from the input audio signal can indicate a need for transport or a trip away from home. In this example, the input audio signal (or the identified request) does not directly express an intent for transport, however the trigger keyword indicates that transport is an ancillary action to at least one other action that is indicated by the request.

The prediction component 120 (or other mechanism of the data processing system 105) can generate, based on the request or the trigger keyword, at least one action data structure associated with the input audio signal. The action data structure can indicate information related to subject matter of the input audio signal. The action data structure can include one or more than one action, such as organic responses to the input audio signal. For example, the input audio signal “OK, I would like to go to the beach this weekend” can include at least one request indicating an interest for a beach weather forecast, surf report, or water temperature information, and at least one trigger keyword, e.g., “go” indicating travel to the beach, such as a need for items one may want to bring to the beach, or a need for transportation to the beach. The prediction component 120 can generate or identify subject matter for at least one action data structure, an indication of a request for a beach weather forecast, as well as subject matter for a content item, such as an indication of a query for sponsored content related to spending a day at a beach. From the request or the trigger keyword the prediction component 120 (or other system 100 component such as the NLP component 110 or the direct action API 135) predicts, estimates, or otherwise determines subject matter for action data structures or for content items. From this subject matter, the direct action API 135 can generate at least one action data structure and can communicate with at least one content provider computing device 155 to obtain at least one content item 155. The prediction component 120 can access the parameters 146 or policies 147 in the data repository 145 to determine or otherwise estimate requests for action data structures or content items. For example, the parameters 146 or policies 147 could indicate requests for a beach weekend weather forecast action or for content items related to beach visits, such as a content item for sunscreen.

The content selector component 125 can obtain indications of any of the interest in or request for the action data structure or for the content item. For example, the prediction component 120 can directly or indirectly (e.g., via the data repository 145) provide an indication of the action data structure or content item to the content selector component 125. The content selector component 125 can obtain this information from the data repository 145, where it can be stored as part of the content data 148. The indication of the action data structure can inform the content selector component 125 of a need for area beach information, such as a weather forecast or products or services the end user may need for a trip to the beach.

From the information received by the content selector component 125, e.g., an indication of a forthcoming trip to the beach, the content selector component 125 can identify at least one content item. The content item can be responsive or related to the subject matter of the input audio query. For example, the content item can include data message identifying as tore near the beach that has sunscreen, or offering a taxi ride to the beach. The content selector component 125 can query the data repository 145 to select or otherwise identify the content item, e.g., from the content data 148. The content selector component 125 can also select the content item from the content provider computing device 155. For example responsive to a query received from the data processing system 105, the content provider computing device 155 can provide a content item to the data processing system 105 (or component thereof) for eventual output by the client computing device 150 that originated the input audio signal, or for output to the same end user by a different client computing device 150.

The audio signal generator component 130 can generate or otherwise obtain an output signal that includes the content item (as well as the action data structure) responsive to the input audio signal. For example, the data processing system 105 can execute the audio signal generator component 130 to generate or create an output signal corresponding to the action data structure or to the content item. The interface component 115 of the data processing system 105 can provide or transmit one or more data packets that include the output signal via the computer network 165 to any client computing device 150. The interface 115 can be designed, configured, constructed, or operational to receive and transmit information using, for example, data packets. The interface 115 can receive and transmit information using one or more protocols, such as a network protocol. The interface 115 can include a hardware interface, software interface, wired interface, or wireless interface. The interface 115 can facilitate translating or formatting data from one format to another format. For example, the interface 115 can include an application programming interface that includes definitions for communicating between various components, such as software components of the system 100.

The data processing system 105 can provide the output signal including the action data structure from the data repository 145 or from the audio signal generator component 130 to the client computing device 150. The data processing system 105 can provide the output signal including the content item from the data repository 145 or from the audio signal generator component 130 to the same or to a different client computing device 150.

The data processing system 105 can also instruct, via data packet transmissions, the content provider computing device 155 or the service provider computing device 160 to provide the output signal (e.g., corresponding to the action data structure or to the content item) to the client computing device 150. The output signal can be obtained, generated, transformed to or transmitted as one or more data packets (or other communications protocol) from the data processing system 105 (or other computing device) to the client computing device 150.

The content selector component 125 can select the content item or the action data structure for the as part of a real-time content selection process. For example, the action data structure can be provided to the client computing device 150 for transmission as audio output by an interface of the client computing device 150 in a conversational manner in direct response to the input audio signal. The real-time content selection process to identify the action data structure and provide the content item to the client computing device 150 can occur within one minute or less from the time of the input audio signal and be considered real-time. The data processing system 105 can also identify and provide the content item to at least one interface of the client computing device 150 that originated the input audio signal, or to a different client computing device 150.

The action data structure (or the content item), for example obtained or generated by the audio signal generator component 130 transmitted via the interface 115 and the computer network 165 to the client computing device 150, can cause the client computing device 150 to execute the audio driver 153 to drive the speaker 154 to generate an acoustic wave corresponding to the action data structure or to the content item. The acoustic wave can include words of or corresponding to the action data structure or content item.

The acoustic wave representing the action data structure can be output from the client computing device 150 separately from the content item. For example, the acoustic wave can include the audio output of “Today it will be sunny and 80 degrees at the beach.” In this example, the data processing system 105 obtains the input audio signal of, for example, “OK, I would like to go to the beach this weekend.” From this information the NLP component 110 identifies at least one request or at least one trigger keyword, and the prediction component 120 uses the request(s) or trigger keyword(s) to identify a request for an action data structure or for a content item. The content selector component 125 (or other component) can identify, select, or generate a content item for, e.g., sunscreen available near the beach. The direct action API 135 (or other component) can identify, select, or generate an action data structure for, e.g., the weekend beach forecast. The data processing system 105 or component thereof such as the audio signal generator component 130 can provide the action data structure for output by an interface of the client computing device 150. For example, the acoustic wave corresponding to the action data structure can be output from the client computing device 150. The data processing system 105 can provide the content item for output by a different interface of the same client computing device 150 or by an interface of a different client computing device 150.

The packet based data transmission of the action data structure by data processing system 105 to the client computing device 150 can include a direct or real-time response to the input audio signal of “OK, I would like to go to the beach this weekend” so that the packet based data transmissions via the computer network 165 that are part of a communication session between the data processing system 105 and the client computing device 150 with the flow and feel of a real-time person to person conversation. This packet based data transmission communication session can also include the content provider computing device 155 or the service provider computing device 160.

The content selector component 125 can select the content item or action data structure based on at least one request or at least one trigger keyword of the input audio signal. For example, the requests of the input audio signal “OK, I would like to go to the beach this weekend” can indicate subject matter of the beach, travel to the beach, or items to facilitate a trip to the beach. The NLP component 110 or the prediction component 120 (or other data processing system 105 components executing as part of the direct action API 135) can identify the trigger keyword “go” “go to” or “to go to” and can determine a transportation request to the beach based at least in part on the trigger keyword. The NLP component 110 (or other system 100 component) can also determine a solicitation for content items related to beach activity, such as for sunscreen or beach umbrellas. Thus, the data processing system 105 can infer actions from the input audio signal that are secondary requests (e.g., a request for sunscreen) that are not the primary request or subject of the input audio signal (information about the beach this weekend).

The action data structures and content items can correspond to subject matter of the input audio signal. The direct action API 135 can execute programs or scripts, for example from the NLP component 110, the prediction component 120, or the content selector component 125 to identify action data structures or content items for one or more of these actions. The direct action API 135 can execute a specified action to satisfy the end user's intention, as determined by the data processing system 105. Depending on the action specified in its inputs, the direct action API 135 can execute code or a dialog script that identifies the parameters required to fulfill a user request. Such code can lookup additional information, e.g., in the data repository 145, such as the name of a home automation service, or it can provide audio output for rendering at the client computing device 150 to ask the end user questions such as the intended destination of a requested taxi. The direct action API 135 can determine necessary parameters and can package the information into an action data structure, which can then be sent to another component such as the content selector component 125 or to the service provider computing device 160 to be fulfilled.

The direct action API 135 of the data processing system 105 can generate, based on the request or the trigger keyword, the action data structures. The action data structures can be generated responsive to the subject matter of the input audio signal. The action data structures can be included in the messages that are transmitted to or received by the service provider computing device 160. Based on the audio input signal parsed by the NLP component 110, the direct action API 135 can determine to which, if any, of a plurality of service provider computing devices 160 the message should be sent. For example, if an input audio signal includes “OK, I would like to go to the beach this weekend,” the NLP component 110 can parse the input audio signal to identify requests or trigger keywords such as the trigger keyword word “to go to” as an indication of a need for a taxi. The direct action API 135 can package the request into an action data structure for transmission as a message to a service provider computing device 160 of a taxi service. The message can also be passed to the content selector component 125. The action data structure can include information for completing the request. In this example, the information can include a pick up location (e.g., home) and a destination location (e.g., a beach). The direct action API 135 can retrieve a template 149 from the data repository 145 to determine which fields to include in the action data structure. The direct action API 135 can retrieve content from the data repository 145 to obtain information for the fields of the data structure. The direct action API 135 can populate the fields from the template with that information to generate the data structure. The direct action API 135 can also populate the fields with data from the input audio signal. The templates 149 can be standardized for categories of service providers or can be standardized for specific service providers. For example, ride sharing service providers can use the following standardized template 149 to create the data structure: {client_device_identifier; authentication_credentials; pick_up_location; destination_location; no_passengers; service_level}.

The content selector component 125 can identify, select, or obtain multiple content items resulting from a multiple content selection processes. The content selection processes can be real-time, e.g., part of the same conversation, communication session, or series of communications sessions between the data processing system 105 and the client computing device 150 that involve common subject matter. The conversation can include asynchronous communications separated from one another by a period of hours or days, for example. The conversation or communication session can last for a time period from receipt of the first input audio signal until an estimated or known conclusion of a final action related to the first input audio signal, or receipt by the data processing system 105 of an indication of a termination or expiration of the conversation. For example, the data processing system 105 can determine that a conversation related to a weekend beach trip begins at the time or receipt of the input audio signal and expires or terminates at the end of the weekend, e.g., Sunday night or Monday morning. The data processing system 105 that provides action data structures or content items for rendering by one or more interfaces of the client computing device 150 or of another client computing device 150 during the active time period of the conversation (e.g., from receipt of the input audio signal until a determined expiration time) can be considered to be operating in real-time. In this example the content selection processes and rendering of the content items and action data structures occurs in real time.

The interface management component 140 can poll, determine, identify, or select interfaces for rendering of the action data structures and of the content items related to the input audio signal. For example, the interface management component 140 can identify one or more candidate interfaces of client computing devices 150 associated with an end user that entered the input audio signal (e.g., “What is the weather at the beach today?”) into one of the client computing devices 150 via an audio interface. The interfaces can include hardware such as sensor 151 (e.g., a microphone), speaker 154, or a screen size of a computing device, alone or combined with scripts or programs (e.g., the audio driver 153) as well as apps, computer programs, online documents (e.g., webpage) interfaces and combinations thereof.

The interfaces can include social media accounts, text message applications, or email accounts associated with an end user of the client computing device 150 that originated the input audio signal. Interfaces can include the audio output of a smartphone, or an app based messaging device installed on the smartphone, or on a wearable computing device, among other client computing devices 150. The interfaces can also include display screen parameters (e.g., size, resolution), audio parameters, mobile device parameters, (e.g., processing power, battery life, existence of installed apps or programs, or sensor 151 or speaker 154 capabilities), content slots on online documents for text, image, or video renderings of content items, chat applications, laptops parameters, smartwatch or other wearable device parameters (e.g., indications of their display or processing capabilities), or virtual reality headset parameters.

The interface management component 140 can poll a plurality of interfaces to identify candidate interfaces. Candidate interfaces include interfaces having the capability to render a response to the input audio signal, (e.g., the action data structure as an audio output, or the content item that can be output in various formats including non-audio formats). The interface management component 140 can determine parameters or other capabilities of interfaces to determine that they are (or are not) candidate interfaces. For example, the interface management component 140 can determine, based on parameters 146 of the content item or of a first client computing device 150 (e.g., a smartwatch wearable device), that the smartwatch includes an available visual interface of sufficient size or resolution to render the content item. The interface management component 140 can also determine that the client computing device 150 that originated the input audio signal has a speaker 154 hardware and installed program e.g., an audio driver or other script to render the action data structure.

The interface management component 140 can determine utilization values for candidate interfaces. The utilization values can indicate that a candidate interface can (or cannot) render the action data structures or the content items provided in response to input audio signals. The utilization values can include parameters 146 obtained from the data repository 145 or other parameters obtained from the client computing device 150, such as bandwidth or processing utilizations or requirements, processing power, power requirements, battery status, memory utilization or capabilities, or other interface parameters that indicate the available of an interface to render action data structures or content items. The battery status can indicate a type of power source (e.g., internal battery or external power source such as via an output), a charging status (e.g., currently charging or not), or an amount of remaining battery power. The interface management component 140 can select interfaces based on the battery status or charging status.

The interface management component 140 can order the candidate interfaces in a hierarchy or ranking based on the utilization values. For example different utilization values (e.g., processing requirements, display screen size, accessibility to the end user) can be given different weights. The interface management component 140 can rank one or more of the utilization values of the candidate interfaces based on their weights to determine an optimal corresponding candidate interface for rendering of the content item (or action data structure). Based on this hierarchy, the interface management component 140 can select the highest ranked interface for rendering of the content item.

Based on utilization values for candidate interfaces, the interface management component 140 can select at least one candidate interface as a selected interface for the content item. The selected interface for the content item can be the same interface from which the input audio signal was received (e.g., an audio interface of the client computing device 150) or a different interface (e.g., a text message based app of the same client computing device 150, or an email account accessible from the same client computing device 150.

The interface management component 140 can select an interface for the content item that is an interface of a different client computing device 150 than the device that originated the input audio signal. For example, the data processing system 105 can receive the input audio signal from a first client computing device 150 (e.g., a smartphone), and can select an interface such as a display of a smartwatch (or any other client computing device for rendering of the content item. The multiple client computing devices 150 can all be associated with the same end user. The data processing system 105 can determine that multiple client computing devices 150 are associated with the same end user based on information received with consent from the end user such as user access to a common social media or email account across multiple client computing devices 150.

The interface management component 140 can also determine that an interface is unavailable. For example the interface management component 140 can poll interfaces and determine that a battery status of a client computing device 150 associated with the interface is low, or below a threshold level such as 10%. Or the interface management component 140 can determine that the client computing device 150 associated with the interface lacks sufficient display screen size or processing power to render the content item, or that the processor utilization rate is too high, as the client computing device is currently executing another application, for example to stream content via the network 165. In these and other examples the interface management component 140 can determine that the interface is unavailable and can eliminate the interface as a candidate for rendering the content item or the action data structure.

Thus, the interface management component 140 can determine that a candidate interface accessible by the first client computing device 150 is linked to an account of an end user, and that a second candidate interface accessible by a second client computing device 150 is also linked to the same account. For example, both client computing devices 150 may have access to the same social media account, e.g., via installation of an app or script at each client computing device 150. The interface management component 140 can also determine that multiple interfaces correspond to the same account, and can provide multiple, different content items to the multiple interfaces corresponding to the common account. For example, the data processing system 105 can determine, with end user consent, that an end user has accessed an account from different client computing devices 150. These multiple interfaces can be separate instances of the same interface (e.g., the same app installed on different client computing devices 150) or different interfaces such as different apps for different social media accounts that are both linked to a common email address account, accessible from multiple client computing devices 150.

The interface management component 140 can also determine or estimate distances between client computing devices 150 associated with candidate interfaces. For example, the data processing system 105 can obtain, with user consent, an indication that the input audio signal originated from a smartphone or virtual reality headset computing device 150, and that the end user is associated with an active smartwatch client computing device 150. From this information the interface management component can determine that the smartwatch is active, e.g., being worn by the end user when the end user enters the input audio signal into the smartphone, so that the two client computing devices 150 are within a threshold distance of one another. In another example, the data processing system 105 can determine, with end user consent, the location of a smartphone that is the source of an input audio signal, and can also determine that a laptop account associated with the end user is currently active. For example, the laptop can be signed into a social media account indicating that the user is currently active on the laptop. In this example the data processing system 105 can determine that the end user is within a threshold distance of the smartphone and of the laptop, so that the laptop can be an appropriate choice for rendering of the content item via a candidate interface.

The interface management component 140 can select the interface for the content item based on at least one utilization value indicating that the selected interface is the most efficient for the content item. For example, from among candidate interfaces, the interface to render the content item at the smartwatch uses the least bandwidth due as the content item is smaller and can be transmitted with fewer resources. Or the interface management component 140 can determine that the candidate interface selected for rendering of the content item is currently charging (e.g., plugged in) so that rendering of the content item by the interface will not drain battery power of the corresponding client computing device 150. In another example, the interface management component 140 can select a candidate interface that is currently performing fewer processing operations than another, unselected interface of for example a different client computing device 150 that is currently streaming video content from the network 165 and therefore less available to render the content item without delay.

The interface management component 140 (or other data processing system 105 component) can convert the content item for delivery in a modality compatible with the candidate interface. For example, if the candidate interface is a display of a smartwatch, smartphone, or tablet computing device, the interface management component 140 can size the content item for appropriate visual display given the dimensions of the display screen associated with the interface. The interface management component 140 can also convert the content item to a packet or other protocol based format, including proprietary or industry standard format for transmission to the client computing device 150 associated with the selected interface. The interface selected by the interface management component 140 for the content item can include an interface accessible from multiple client computing devices 150 by the end user. For example, the interface can be or include a social media account that the end user can access via the client computing device 150 that originated the input audio signal (e.g., a smartphone) as well as other client computing devices such as tabled or desktop computers or other mobile computing devices.

The interface management component 140 can also select at least one candidate interface for the action data structure. This interface can be the same interface from which the input audio signal was obtained, e.g., a voice activated assistant service executed at a client computing device 150. This can be the same interface or a different interface than the interface management component 140 selects for the content item. The interface management component 140 (or other data processing system 105 components) can provide the action data structure to the same client computing device 150 that originated the input audio signal for rendering as audio output as part of the assistant service. The interface management component 140 can also transmit or otherwise provide the content item to the selected interface for the content item, in any converted modality appropriate for rendering by the selected interface.

Thus, the interface management component 140 can provide the action data structure as audio output for rendering by an interface of the client computing device 150 responsive to the input audio signal received by the same client computing device 150. The interface management component 140 can also provide the content item for rendering by a different interface of the same client computing device 150 or of a different client computing device 150 associated with the same end user. For example, the action data structure, e.g., “it will be sunny and 80 degrees at the beach on Saturday” can be provided for audio rendering by the client computing device as part of an assistant program interface executing in part at the client computing device 150, and the content item e.g., a text, audio, or combination content item indicating that “sunscreen is available from the convenience store near the beach” can be provided for rendering by an interface of the same or a different computing device 150, such as an email or text message accessible by the same or a different client computing device 150 associated with the end user.

Separating the content item from the action data structure and sending the content item as, for example, a text message rather than an audio message can result in reduced processing power for the client computing device 150 that accesses the content item since, for example, text message data transmissions are less computationally intensive than audio message data transmissions. This separation can also reduce power usage, memory storage, or transmission bandwidth used to render the content item. This results in increased processing, power, and bandwidth efficiencies of the system 100 and devices such as the client computing devices 150 and the data processing system 105. This increases the efficiency of the computing devices that process these transactions, and increases the speed with which the content items can be rendered. The data processing system 105 can process thousands, tens of thousands or more input audio signals simultaneously so the bandwidth, power, and processing savings can be significant and not merely incremental or incidental.

The interface management component 140 can provide or deliver the content item to the same client computing device 150 (or a different device) as the action data structure subsequent to delivery of the action data structure to the client computing device 150. For example, the content item can be provided for rendering via the selected interface upon conclusion of audio output rendering of the action data structure. The interface management component 140 can also provide the content item to the selected interface concurrent with the provision of the action data structure to the client computing device 150. The interface management component 140 can provide the content item for delivery via the selected interface within a pre-determined time period from receipt of the input audio signal by the NLP component 110. The time period, for example, can be any time during an active length of the conversation of session. For example, if the input audio signal is “I would like to go to the beach this weekend” the pre-determined time period can be any time from receipt of the input audio signal through the end of the weekend, e.g., the active period of the conversation. The pre-determined time period can also be a time triggered from rendering of the action data structure as audio output by the client computing device 150, such as within 5 minutes, one hour or one day of this rendering.

The interface management component 140 can provide the action data structure to the client computing device 150 with an indication of the existence of the content item. For example, the data processing system 105 can provide the action data structure that renders at the client computing device 150 to provide the audio output “it will be sunny and 80 degrees at the beach on Saturday, check your email for more information.” The phrase “check your email for more information” can indicate the existence of a content item, e.g., for sunscreen, provided by the data processing system 105 to an interface (e.g., email). In this example, sponsored content can be provided as content items to the email (or other) interface and organic content such as the weather can be provided as the action data structure for audio output.

The data processing system 105 can also provide the action data structure with a prompt that queries the user to determine user interest in obtaining the content item. For example, the action data structure can indicate “it will be sunny and 80 degrees at the beach on Saturday, would you like to hear about some services to assist with your trip?” The data processing system 105 can receive another audio input signal from the client computing device 150 in response to the prompt “would you like to hear about some services to assist with your trip?” such as “sure”. The NLP component 110 can parse this response, e.g., “sure” and interpret it as authorization for audio rendering of the content item by the client computing device 150. In response, the data processing system 105 can provide the content item for audio rendering by the same client computing device 150 from which the response “sure” originated.

The data processing system 105 can delay transmission of the content item associated with the action data structure to optimize processing utilization. For example, the data processing system 105 provide the action data structure for rendering as audio output by the client computing device in real-time responsive to receipt of the input audio signal, e.g., in a conversational manner, and can delay content item transmission until an off-peak or non-peak period of data center usage, which results in more efficient utilization of the data center by reducing peak bandwidth usage, heat output or cooling requirements. The data processing system 105 can also initiate a conversion or other activity associated with the content item, such as ordering a car service responsive to a response to the action data structure or to the content item, based on data center utilization rates or bandwidth metrics or requirements of the network 165 or of a data center that includes the data processing system 105.

Based on a response to a content item or to the action data structure for a subsequent action, such as a click on the content item rendered via the selected interface, the data processing system 105 can identify a conversion, or initiate a conversion or action. Processors of the data processing system 105 can invoke the direct action API 135 to execute scripts that facilitate the conversion action, such as to order a car from a car share service to take the end user to or from the beach. The direct action API 135 can obtain content data 148 (or parameters 146 or policies 147) from the data repository 145, as well as data received with end user consent from the client computing device 150 to determine location, time, user accounts, logistical or other information in order to reserve a car from the car share service. Using the direct action API 135, the data processing system 105 can also communicate with the service provider computing device 160 to complete the conversion by in this example making the car share pick up reservation.

FIG. 1C depicts a flow diagram 200 for multi-modal transmission of packetized data in a voice activated computer network environment. The data processing system 105 can receive the input audio signal 205, e.g., “OK, I would like to go to the beach this weekend.” In response, the data processing system generates at least one action data structure 210 and at least one content item 215. The action data structure 205 can include organic or non-sponsored content, such as a response for audio rendering stating “It will be sunny and 80 degrees at the beach this weekend” or “high tide is at 3 pm.” The data processing system 105 can provide the action data structure 210 to the same client computing device 150 that originated the input audio signal 205, for rendering by a candidate interface of the client computing device 150, e.g., as output in a real time or conversational manner as part of a digital or conversational assistant platform.

The data processing system 105 can select the candidate interface 220 as a selected interface for the content item 215, and can provide the content item 215 to the selected interface 220. The content item 215 can also include a data structure, converted to the appropriate modality by the data processing system 105 for rendering by the selected interface 220. The content item 215 can include sponsored content, such as an offer to rent a beach chair for the day, or for sunscreen. The selected interface 220 can be part of or executed by the same client computing device 150 or by a different device accessible by the end user of the client computing device 150. Transmission of the action data structure 210 and the content item 215 can occur at the same time or subsequent to one another. The action data structure 210 can include an indicator that the content item 215 is being or will be transmitted separately via a different modality or format to the selected interface 200, alerting the end user to the existence of the content item 215.

The action data structure 210 and the content item 215 can be provided separately for rendering to the end user. By separating the sponsored content (content item 215) from the organic response (action data structure 210) audio or other alerts indicating that the content item 215 is sponsored do not need to be provided with the action data structure 210. This can reduce bandwidth requirements associated with transmission of the action data structure 210 via the network 165 and can simplify rendering of the action data structure 210, for example without audio disclaimer or warning messages.

The data processing system 105 can receive a response audio signal 225. The response audio signal 225 can include an audio signal such as, “great, please book me a hotel on the beach this weekend.” Receipt by the data processing system 105 of the response audio signal 225 can cause the data processing system to invoke the direct action API 135 to execute a conversion to, for example, book a hotel room on the beach. The direct action API 135 can also communicate with at least one service provider computing device 160 to provide information to the service provider computing device 160 so that the service provider computing device 160 can complete or confirm the booking process.

FIG. 2 illustrates an environment 200 in which the present invention may be used. A user device (also referred to as a “client” or “client device”) 250 may include a browser facility (such as the Explorer and pocket-PC Explorer browsers from Microsoft, the Opera Web Browser from Opera Software of Norway, the Navigator browser from AOL/Time Warner, the Mozilla browser, etc.), an e-mail facility (e.g., Outlook from Microsoft), etc. A search engine 230 may permit user devices 150 to search collections of documents (e.g., Web pages). A content server 155 may permit user devices 150 to access documents. An e-mail server (such as Hotmail from Microsoft Network, Yahoo Mail, etc.) 240 may be used to provide e-mail functionality to user devices 150. A service provider server 160 may be used to serve digital components to user devices 150. The digital components may be served in association with search results provided by the search engine 230. However, content-relevant digital components may be served in association with content provided by the content provider server 155, and/or e-mail supported by the e-mail server 240 and/or user device e-mail facilities.

As discussed in the '900 application (introduced above), digital components may be targeted to documents served by content servers. Thus, one example of a content provider 155 is a content provider server 155 that receives requests for documents (e.g., articles, discussion threads, music, video, graphics, search results, Web page listings, etc.), and retrieves the requested document in response to, or otherwise services, the request. The content server may submit a request for digital components to the server 120/210. Such a digital component request may include a number of digital components desired. The digital component request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, user device characteristics, etc. The request may also include end user device characteristics.

The content provider server 155 may combine the requested document with one or more of the digital components provided by the server 120/210. This combined information including the document content and digital component(s) is then forwarded towards the end user device 150 that requested the document, for presentation to the user. Finally, the content provider server 155 may transmit information about the digital components and how, when, and/or where the digital components are to be rendered (e.g., position, selection or not, impression time, impression date, size, conversion or not, end user device characteristics, etc.) back to the server 120/210. Alternatively, or in addition, such information may be provided back to the server 120/210 by some other means.

Another example of a content provider 155 is the search engine 230. A search engine 230 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 230 may submit a request for digital components to the server 120/210. The request may include a number of digital components desired. This number may depend on the search results, the amount of screen or page space occupied by the search results, the size and shape of the ads, etc. In one embodiment, the number of desired digital components will be from one to ten, and preferably from three to five. The request for digital components may also include the query (as entered or parsed), information based on the query (such as geolocation information, whether the query came from an affiliate and an identifier of such an affiliate, and/or as described below, information related to, and/or derived from, the search query), user device characteristics, and/or information associated with, or based on, the search results. Such information may include, for example, identifiers related to the search results (e.g., document identifiers or “dociDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc. The request may also include end user device characteristics.

The search engine 230 may combine the search results with one or more of the digital components provided by the server 120/210. This combined information including the search results and digital component(s) is then forwarded towards the user that submitted the search, for presentation to the user. Preferably, the search results are maintained as distinct from the ads, so as not to confuse the user between paid digital components and presumably neutral search results.

Finally, the search engine 230 may transmit information about the digital component and when, where, and/or how the digital component was to be rendered (e.g., position, selection or not, impression time, impression date, size, conversion or not, end user device characteristics, etc.) back to the server 120/210. As described below, such information may include information for determining on what basis the digital component was determined relevant (e.g., strict or relaxed match, or exact, phrase, or broad match, etc.) Alternatively, or in addition, such information may be provided back to the server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as a content provider 155. Thus, e-mails may be thought of as documents, and targeted digital components may be served in association with such documents. For example, one or more digital components may be served in, under over or otherwise in association with an e-mail.

Although the foregoing examples described servers as (i) requesting ads, and (ii) combining them with content, one or both of these operations may be performed by a client device (such as an end user computer for example).

Online digital components may have various intrinsic features. Such features may be specified by an application and/or a service provider. These features are referred to as “digital component features” below. For example, in the case of a text ad, digital component features may include a title line, digital component text, and an embedded link. In the case of an image ad, digital component features may include images, executable code, and an embedded link. Depending on the type of online ad, digital component features may include one or more of the following: text, a link, an audio file, a video file, an image file, executable code, embedded information, etc.

When an online digital component is served, one or more parameters may be used to describe how, when, and/or where the digital component was served. These parameters are referred to as “serving parameters” below. Serving parameters may include, for example, one or more of the following: features of (including information on) a document on which, or with which, the digital component was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the digital component on the page on which it was served, a position (spatial or temporal) of the digital component relative to other digital components served, an absolute size of the ad, a size of the digital component relative to other ads, a color of the ad, a number of other digital components served, types of other digital components served, time of day served, time of week served, time of year served, etc. Naturally, there are other serving parameters that may be used in the context of the invention.

Although serving parameters may be extrinsic to digital component features, they may be associated with a digital component as serving conditions or constraints. When used as serving conditions or constraints, such serving parameters are referred to simply as “serving constraints” (or “targeting criteria”). For example, in some systems, a service provider may be able to target the serving of its digital component by specifying that it is only to be served on weekdays, no lower than a certain position, only to users in a certain location, etc. As another example, in some systems, a service provider may specify that its digital component is to be served only if a page or search query includes certain keywords or phrases. As yet another example, in some systems, a service provider may specify that its digital component is to be served only if a document being served includes certain topics or concepts, or falls under a particular cluster or clusters, or some other classification or classifications. Finally, in some systems, a service provider may specify that its digital component is to be served only to (or is not to be served to) user devices having certain characteristics.

“Digital component information” may include any combination of digital component features, digital component serving constraints, information derivable from digital component features or digital component serving constraints (referred to as “digital component derived information”), and/or information related to the digital component (referred to as “digital component related information”), as well as an extension of such information (e.g., information derived from digital component related information).

The ratio of the number of selections (e.g., clickthroughs) of a digital component to the number of impressions of the digital component (i.e., the number of times a digital component is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the service provider server, and consummates a purchase there before leaving that Web page. Alternatively, a conversion may be defined as a user being shown an ad, and making a purchase on the service provider server within a predetermined time (e.g., seven days). In yet another alternative, a conversion may be defined by a service provider to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the digital component (i.e., the number of times a digital component is rendered) is referred to as the “conversion rate.” If a conversion is defined to be able to occur within a predetermined time since the serving of an ad, one possible definition of the conversion rate might only consider digital components that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Digital component spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, and Mozilla), a media player (e.g., a MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

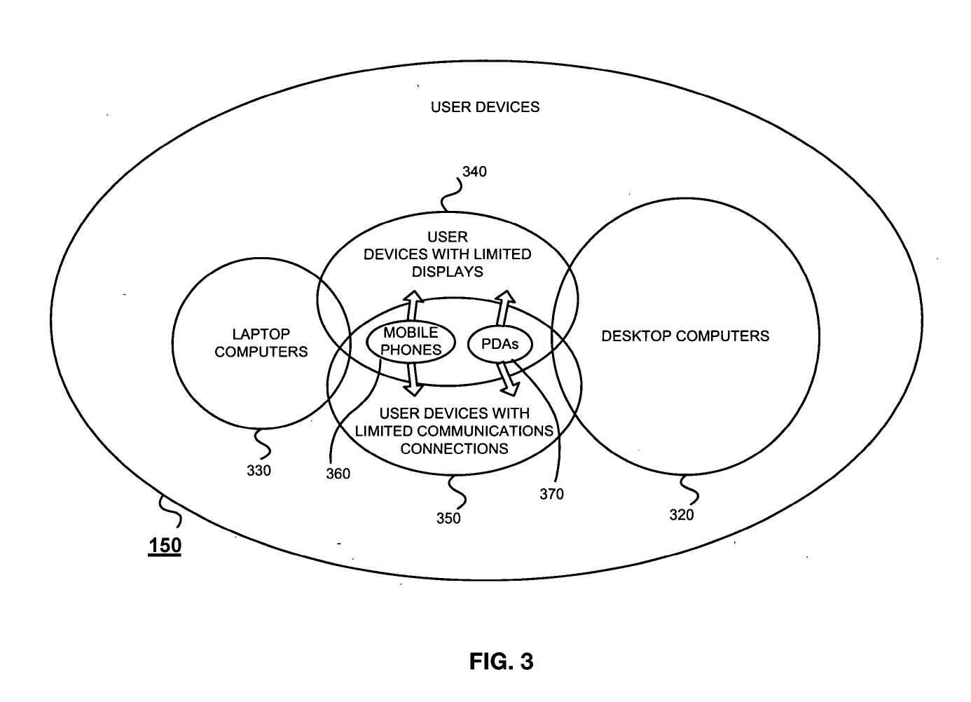

FIG. 3 is a Venn diagram illustrating a classification of user devices 150 consistent with the present invention. Some user devices 340 may have limited displays. Some user devices 350 may have limited communications connections. Most laptop computers 330 will not have limited displays or communications connections, but some may have limited displays and/or limited communications connections. Similarly, most desktop computers 320 will not have limited displays or communications connections, but some may have limited displays and/or limited communications connections. As shown, most present mobile telephones 360 and personal digital assistants (PDAs) 370 have limited displays and limited communications connections. However, as indicated by the arrows, displays and/or communications connections of such devices may improve. Similarly, other devices (not shown), such as handheld and/or wireless devices may have limited displays and/or limited communications connections.

A limited or small display may be thought of as one that cannot render Web pages in a manner satisfying to most users or a target set of users, due to size, and/or resolution. A 3″ diagonal display common on most current generation PDAs is one example of a limited display in the context of most Web pages authored for personal computers. A 1.5″ diagonal display common on most mobile telephones is another example of a limited display in the context of most Web pages authored for personal computers. Similarly, a slow communications connection speed may be thought of as one that is too slow to permit loading Web pages in a manner satisfying to most users, or a target set of users. A 9.3 Kbps modem is one example of a slow connection speed in the context of loading most Web pages authored for personal computers. Similarly, a slow processor may be thought of as one that is too slow to permit a loaded Web page to be rendered in a manner satisfying to most users, or a target set of users. Finally, a limited user device may be thought of as one that cannot render requested Web pages in a manner satisfying to most users, or a target set of users (e.g., due to some combination of screen size, communications connection speed, and/or processor speed). What constitutes a limited user device, a limited display, a slow connection speed, and/or a slow processor may be defined by a service provider, a digital component serving system, an end user, or some combination of definitions from these parties and entities.

“Device information” about a client device or an end user device may include information about whether or not the device has call functionality, a home-base area code of the device, an area code of a present location of the device, qualitative and/or quantitative information about processor speed, display size, display resolution, communications speed, etc. of the device, etc.

Although the present invention may be used with any user device having telephone call functionality, it is especially advantageous for use with user devices having telephone call functionality but having small displays, slow communications connections, and/or slow processors.

As discussed above, rendering a linked landing Web page upon digital component selection in accordance with standard clickthrough model might not be advisable for devices with limited displays and/or limited communications connections, such as wireless browsers. For example, the service provider server or Web page might not look good, and indeed might not even function, on a wireless telephone with rendering capabilities. In such a case, rendering or trying to render a digital component landing page when a digital component is selected may be harmful and make the service provider look bad. As another example, making a connection and downloading another Web page may be quite slow for devices with limited communications connections. For example, Sprint's wireless network has been only 9.6K baud. Making the user incur another delay before getting a potentially mediocre experience might not be advisable. Further, on devices with limited displays, it is more difficult, perceptually, to keep track of one's state; making the user look at an intermediate text page will only serve to exacerbate this difficulty. Even if the service provider's landing Web page and Website function well on a device with a limited display and/or communications connection, such as a mobile telephone, the chances of a conversion (e.g., a transaction being consummated) may remain quite small due to input limitations of mobile telephones. For example; entering shipping information and credit card information with a mobile telephone keyboard may be slow and frustrating. Finally, even if the user device is not limited in terms of rendering a selected Web page, it may nonetheless be advantageous to provide a digital component with call-on-select functionality since such digital components may have a higher conversion rate than digital components in which a landing Web page is loaded in response to a selection.

The present invention may be used to (i) provide user device information (such as whether or not the user device has a slow display, a slow communication connection, a slow processor, a limited user input, and/or call functionality) in a digital component request, (ii) select and/or score digital components using user device information, (iii) display or otherwise render digital components with a call-on-select feature, and/or (iv) initiate a call responsive to a call selection. The present invention may do so using various techniques, described below. As will be appreciated by those skilled in the art, at least some of these techniques may be used alone, or in combination.

Some of the exemplary embodiments are described below with respect to a mobile telephone. In some of the exemplary embodiments described below, a call-on-select “button”, such as a telephone icon for example, is displayed with (e.g., within, adjacent to, etc.) a digital component. The call-on-select button indicates that if the user clicks the button (or perhaps other portions of the ad), a call will be generated from the mobile telephone. These exemplary embodiments have a number of advantages. If the user is using a mobile telephone, the user may not want to interact via the small screen. However, the user can be connected with the service provider by voice. If a button or hyperlink is used to initiate a telephone call, the user does not need to write down or try to remember a telephone number. Orders can be placed without requiring the user to scroll through various information and enter information using often limited keypads. Finally, client devices can be directly connected with service providers.

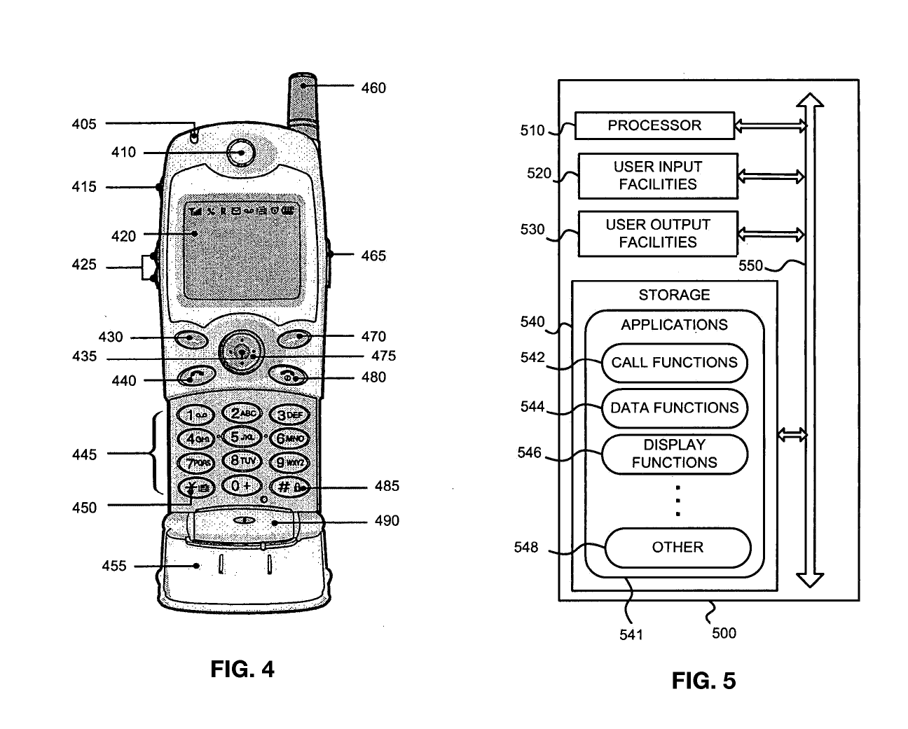

FIGS. 4 and 5 are diagrams of mobile telephones with which with the present invention may be used. The mobile telephone 400 of FIG. 4 may include one or more of a call indicator 405, an earpiece 410, a record key 415, a display screen 420, an up/down side key 425, a soft left key 430, an easy key 435, a send key 440, numeric keys 445, a star key 450, an active flip 455, an antenna 460, a hands-free connector 465, a soft right key 470, navigation keys 475, an end/power key 480, a hash or pound key 485 and a microphone 490.

FIG. 5 is a block diagram of a mobile telephone 500 with which the present invention may be used. The mobile telephone 500 may include one or more processors 510, one or more user input facilities 520 (e.g., keys and microphone), one or more user output facilities 530 (e.g., display and speaker) and one or more storage facilities 540. These facilities can communicate with one another via one or more buses or networks 550. The storage facilities 540 may include various applications 541, such as applications that support call functions 542, applications that support data functions 544, applications that support display functions 546, as well as additional applications 548. The data functions 544 may include browser functions. Finally application program interfaces (APIs) may be provided which allow data functions 544 to access call functions 542.

Currently, some telephones can extract telephone number information from short-message-service (SMS) messages (e.g., by looking for simple patterns ###-###-####, (###) ###-####, etc.) Therefore, a digital component delivered in SMS can include a telephone number that will be recognized—and if selected can cause the telephone to dial the telephone number. Microsoft has already installed a feature in its pocket-PC Explorer which uses the following syntax:
<a href=“te1:12063722651”> call me</a>

which basically puts up a link that, if pressed, calls the telephone number in the “tel:” tag.

Most phones that support data and voice modes usually include a limited amount of interaction between the data and voice sides. However, dialing from a Web page is possible by having an application on the user device use APIs, available on many mobile telephones, to dial a telephone number that is often exposed to the data side. The mobile client applications may be developed using various commercially available platforms such as Binary Runtime Environment for Wireless ((BREW) from Qualcomm of Sandie go, California), Java 2 Micro Edition ((J2ME) from Sun of Santa Clara, Calif.), Symbian, Smartphone, etc., for example. BREW and J2ME allow commands, such as initiative voice-call, to be sent to applications for the voice functions of the telephone.

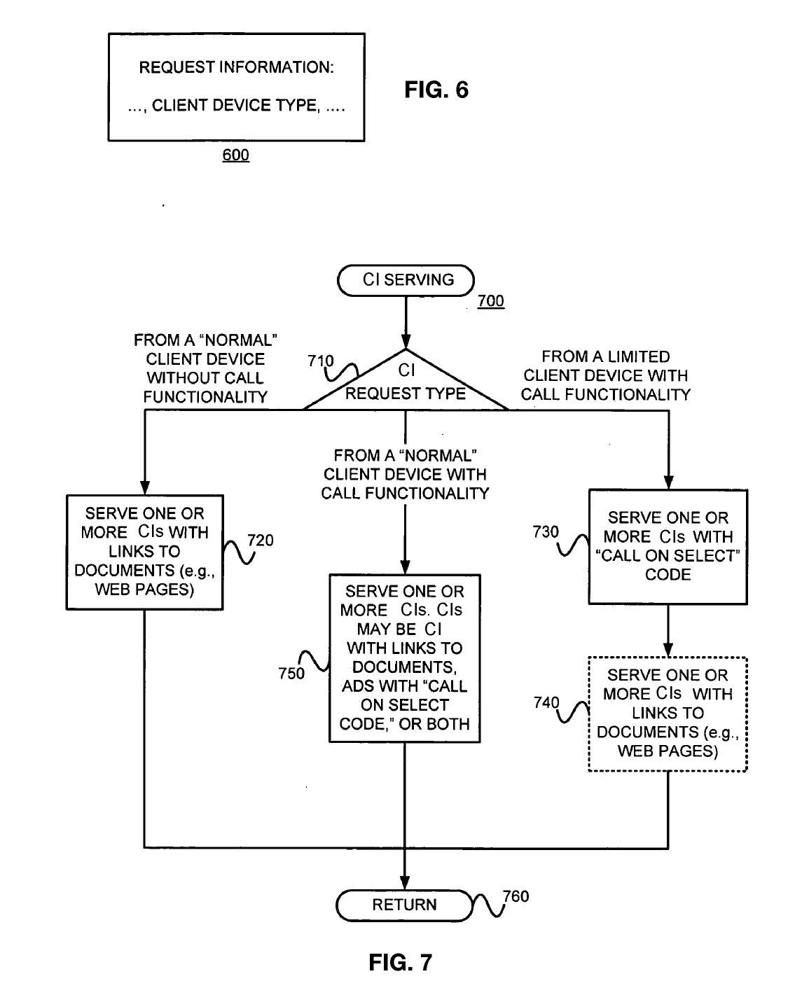

FIG. 6 illustrates an exemplary data structure 600 that is consistent with the present invention, for storing a digital component request message. Among other things, such as information used for targeting relevant digital components for example, the message 600 may include client device type information 600. Such client device type information may be used to determine one or more of (i) whether or not the user device has a small display, and/or a size of the display, (ii) whether or not the user device has a low resolution display, and/or the resolution of the display, (iii) whether or not the user device has a limited communications connection, and/or a speed of the connection (which may instedigital component be inferred), (iv) whether or not the user device has a slow processor, and/or the speed of the processor, (v) whether or not the user device is limited in terms of loading and rendering a Web page, (vi) whether or not the user device has call functionality, (vii) whether or not the user device has supports various authoring languages (e.g., a HTML, SGML, XML, WAP, WAP 2.0, dHTML, xHTML, Java, Javascript, etc.), (vii) whether the user device is supporting a currently active (not terminated) telephone call, (viii) whether or not the user device has a limited user input, (ix) what type of user input is provided (e.g., touch screen, stylus, limited keypad, full keyboard, pointers, etc.), etc. Such user device information may be used in a determination of whether or not to serve certain digital components or certain types of ads, and/or how to score competing ads.

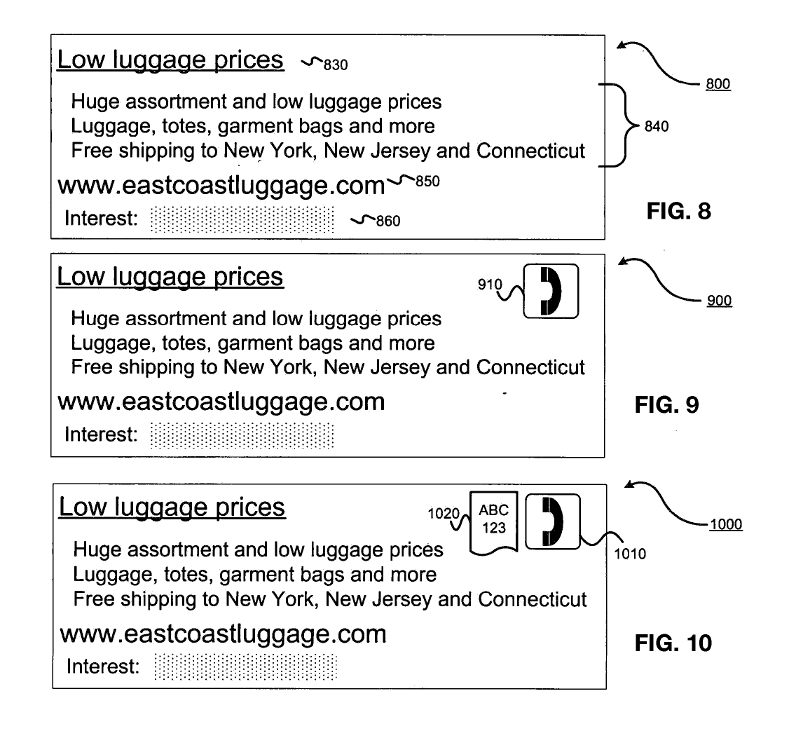

Other ways of communication or inferring user device type may be used and the present invention is not limited to the foregoing message data structure, nor is it limited to the types of information listed. FIG. 7 is a flow diagram of an exemplary method 700 for performing digital component serving operations in a manner consistent with the present invention. As indicated by block 710, different branches of the method 700 may be performed depending on a digital component request type. If the digital component request type is (sourced) from a “normal” client device without call functionality, one or more digital components with links to documents (e.g., Web pages) are served (ACT 720) before the method 700 is left (Node 760). Examples of such digital components include keyword-targeted text ads. The digital components may be served in accordance with a digital component score. The score of a digital component may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the digital component (e.g., selection rate, user rating, conversion rate, etc.), etc. A “normal” client device is one that is not a limited client device. For example, a normal client device may be one with a normal display and/or a normal connection speed such as a personal computer for example.

Referring back to block 710, if the digital component request type is (sourced) from a “normal” client device with call functionality, one or more digital components can be served. The ad(s) may be ad(s) with links to documents, ad(s) with “call on select” code, or both. (ACT 750) Thus, one or more digital components with “call-on-select” code may be served, or at least compete for serving. For example, even if a user device can load and render a Web page in a way satisfactory to most users, or a group of target users, it may be advantageous to serve call-on-select digital components since such digital components may have a higher conversion rate, and/or may be expected to generate more revenue for the service provider. This higher conversion rate may be reflected in the score of the ads. As was the case with block 720 of the left branch, the digital components may be served in accordance with a digital component score. The score of a digital component may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the digital component (e.g., selection rate, user rating, conversion rate, etc.), etc. In addition, the score of a digital component may be a function of how the digital component performs (e.g., in terms of selection rate, conversion rate, etc.) on devices with call functionality.

Referring back to block 710, if, on the other hand, the request type is from a “limited” client device with call functionality (e.g., a client device with a small display, a slow connection speed, and/or slow processing speed), the right branch of method 700 is performed. For example, one or more digital components with call-on-select code may be served (ACT 730) before the method 700 is left (Node 750). As shown, one or more digital components with links to documents (e.g., Web pages) may also be served. (ACT 740) As was the case with block 720 of the left branch, the digital components may be served in accordance with a digital component score. The score of a digital component may be a function of one or more of (i) its relevance to a current user interest (e.g., inferred from a search query or document), (ii) relevance to a user type, (iii) relevance to a user, (iv) an offer per impression, (v) an offer per user action (e.g., selection, conversion, etc.), (vi) a performance parameter of the digital component (e.g., selection rate, user rating, conversion rate, etc.), etc. In addition, the score of a digital component may be a function of how the digital component performs (e.g., in terms of selection rate, conversion rate, etc.) on devices with call functionality and limited displays and/or limited communications connections.

In an alternative embodiment, as long as the user device has call functionality, all types of digital components may be considered, but the score of the digital components considers the user device type. For example, the user device type may affect a performance parameter of a digital component used in determining the ad's score.

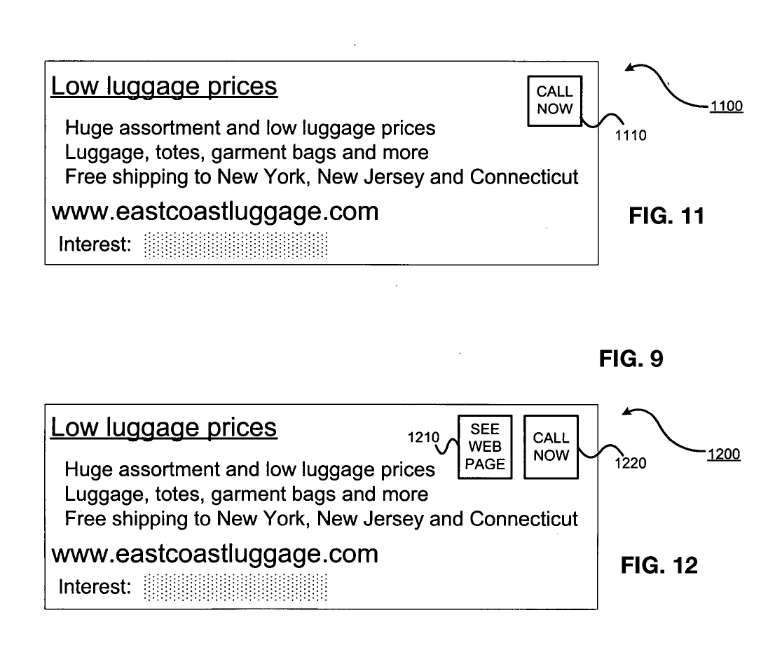

FIGS. 8-12 are exemplary digital component displays consistent with the present invention. FIG. 8 is a text digital component 800 which may include one or more of a title line 830, one or more lines of text 840, a World Wide Web address 850 and an interest meter 860. Typically, when such a digital component is selected by a user clicking on the ad, an associated Web page is loaded onto the user's browser. However, as discussed above, this may not be desirable for certain user devices.

FIG. 9 is a text digital component 900 which includes call-on-select functionality as indicated by icon button 910. In some embodiments of the present invention, a call (to a telephone number associated with the digital component by the service provider) is initiated when the icon button 910 is selected (e.g., via touch screen, stylus, keystroke, pointer, such as a joystick, a touchpad, a track call, etc.). Depending on the embodiment, if a portion of the digital component 900 other than the icon button 910 is selected, a call can be initiated, or, alternatively, a linked document can be rendered on the browser of the device.

FIG. 10 is a text digital component 1000 which includes call-on-select functionality as indicated by icon button 1010, as well as linked document functionality as indicated by icon button 1020. In some embodiments of the present invention, a call (to a telephone number associated with the digital component by the service provider) is initiated when the icon button 1010 is selected and a linked document is rendered on the browser when the icon button 1020 is selected. Depending on the embodiment, if a portion of the digital component 1000 other than the icons buttons 1010 and 1020 is selected, a call can be initiated, or, alternatively, a linked document can be rendered on the browser of the device.

FIG. 11 is a text digital component 1100 which includes call-on-select functionality as indicated by button 1110. In some embodiments of the present invention, a call (to a telephone number associated with the digital component by the service provider) is initiated when the button 1110 is selected. Depending on the embodiment, if a portion of the digital component 1100 other than the button 1110 is selected, a call can be initiated, or, alternatively, a linked document can be rendered on the browser of the device. FIG. 12 is a text digital component 1200 which includes call-on-select functionality as indicated by button 1210, as well as linked document functionality as indicated by button 1220. In some embodiments of the present invention, a call (to a telephone number associated with the digital component by the service provider) is initiated when the button 1210 is selected and a linked document is rendered on the browser when the button 1220 is selected. Depending on the embodiment, if a portion of the digital component 1000 other than the buttons 1210 and 1220 is selected a call can be initiated, or, alternatively, a linked document can be rendered on the browser of the device. Before, concurrent with, or after the call initiation, informational messages (e.g., “YOU ARE NOW CALLING ______” can be rendered on the telephone).

Digital components with both call and linked document functionality may have different performance parameters associated with the different functionality. Alternatively, or in addition, the digital component may have different offers associated with different user actions (e.g., a first offer for a call and a second offer for a linked document referral). Referring back to method 700, the scoring of digital components may consider one or more of the different performance parameters and/or one more of the different offers.

Various alternative functionality of the digital components described above may be performed depending on one or more of default values of the server, service provider preferences, user or user set preferences, content owner preferences, content owner group preferences, etc.

Although text digital components were shown in FIGS. 8-12, other types of ads, such as those listed in §4.1.1. above, can be used in a manner consistent with the present invention. Further, different ways of navigating to (a) loading a document and/or (b) dialing a telephone number are possible. For example, when a user selects an ad, they may be asked whether they want to visit the service provider's Web page or talk to the service provider.

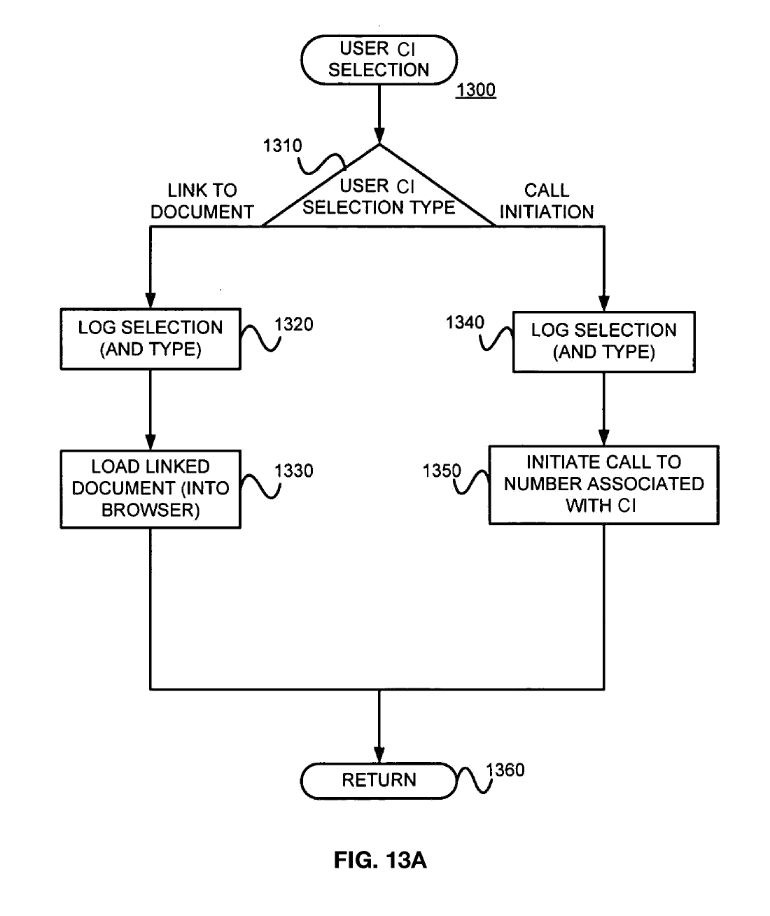

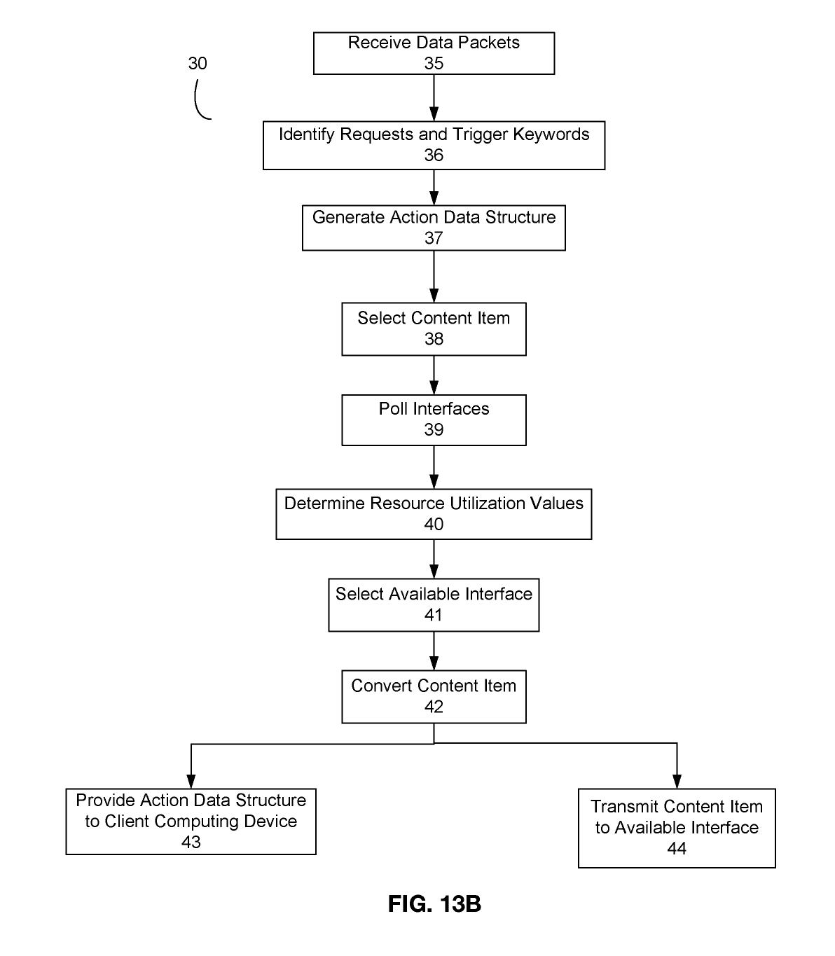

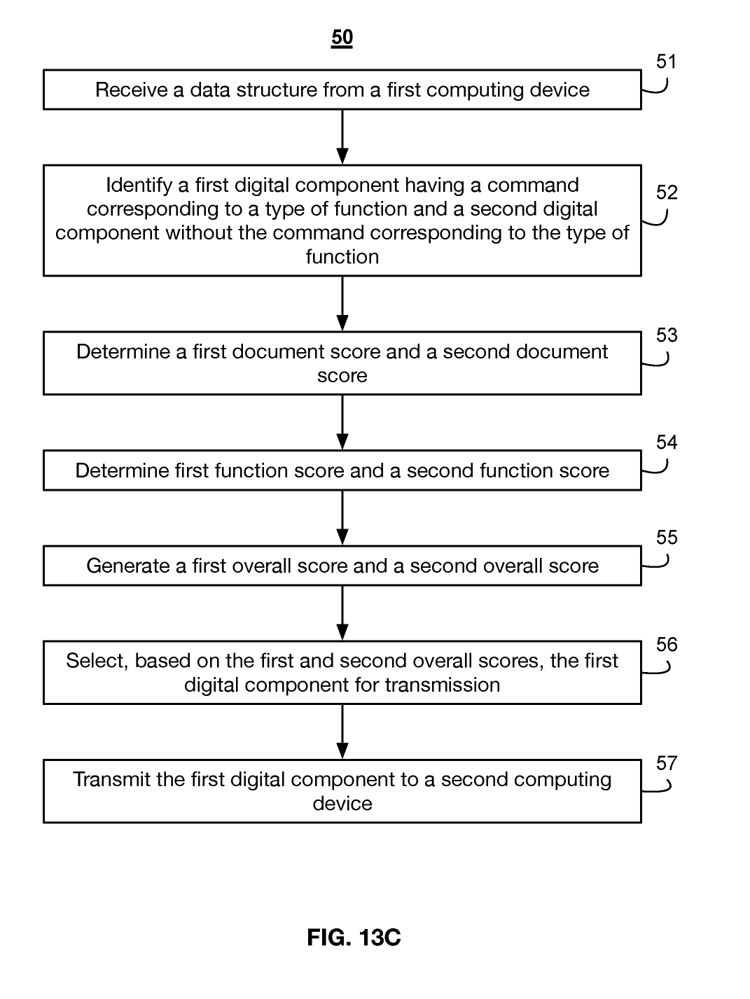

FIG. 13A is a flow diagram of an exemplary method 1300 for performing user digital component selection operations in a manner consistent with the present invention. As indicated by block 1310, different branches of the method 1300 may be performed depending on a user digital component selection type. (Recall, e.g., digital components 900, 1000, 1100 and 1200 described above.) If the user digital component selection type is a link to document, the left branch of the method 1300 is performed, while if the user digital component selection type is a call initiation, the right branch of the method 1300 is performed.

If the user digital component selection is a link to document, the digital component selection (and type) may be logged (ACT 1320) and the linked document may be rendered on the user device (e.g., loaded into a browser) (ACT 1330), before the method 1300 is left (Node 1360). If, on the hand, the user digital component selection is a call initiation, the digital component selection (and type) may be logged (ACT 1340) and a call to a number associated with the digital component may be initiated (ACT 1350) before the method 1300 is left (Node 1360).

FIG. 13B depicts a method 30 of multi-modal transmission of packetized data in a voice activated computer network environment. The method 30 can receive data packets (ACT 35). For example, the NLP component 110, executed by the data processing system 105, can receive from the client computing device 105 data packets that include an input audio signal (ACT 35). The data packets can be received (ACT 35) via the network 165 as packet or other protocol based data transmissions. The method 30 can identify, from the input audio signal, requests or trigger keywords corresponding to the requests (ACT 36). For example, the NLP component 110 can parse the input audio signal to identify requests that relate to subject matter of the input audio signal, or to identify trigger keywords that can indicate, for example, actions associated with the requests.

The method 30 can generate at least one action data structure (ACT 37). For example, the direct action API 135 can generate action data structures (ACT 37) based on the requests or trigger keywords. The action data structures can indicate organic or non-sponsored content related to the input audio signal. The method 30 can select at least one content item (ACT 38). For example, the content selector component 125 can receive the request(s) or the trigger keyword(s) and based on this information can select one or more content items. The content items can include sponsored items having subject matter that relates to subject matter of the request or of the trigger keyword. The content items can be selected by the content selector component 125 via a real-time content selection process.

The method 30 can poll a plurality of interfaces to determine at least one candidate interface (ACT 39). The candidate interfaces can include candidate interfaces for rendering of the selected content item (or action data structure). For example, the interface management component 140 can query interfaces to obtain utilization values, e.g., parameter information or other characteristics about the interfaces (ACT 40). Based on the utilization values the interface management component 140 can select (ACT 41) at least one candidate interface as a selected interface for rendering of the content item (or of the action data structure). The method 30 can include converting the content item to a modality for rendering via the selected interface (ACT 42). For example the data processing system 105 or component thereof such as the interface management component 140 can convert the content item for rendering in a content item slot of an online document (e.g., for display as an email (e.g., via a selected email interface) or as a text message for display in a chat app).

The method 30 can provide the action data structure to the client computing device 150 for rendering (ACT 43) and can transmit the content item to the candidate interface selected for rendering of the content item (ACT 44). For example, via the interface 115 the interface management component 140 can provide the action data structure to the client computing device 150 for rendering as audio output responsive to the input audio signal (ACT 43). The data processing system can also transmit the content item to the selected interface on the same or a different client computing device 150 for rendering in the converted modality (ACT 44).

FIG. 13C illustrates a block diagram of an example method 50 for configuration-based function delivery. The method 50 can include receiving, from a first computing device via a network, a data structure that can include device configuration information (ACT 51). The method 50 can also include identifying, responsive to a request from the first computing device that accessed an online resource having content, a first digital component and a second digital component (ACT 52). The method 50 can include determining, based on the content of the online resource accessed by the first computing device, a first document score for the first digital component and a second document score for the second digital component (ACT 53). The method 50 can include determining a first function score for the first digital component having the command and a second function score for the second digital component item without the command (ACT 54). The method 50 can include generating a first overall score for the first digital component and a second overall score for the second digital component (ACT 55). The method 50 can include selecting, based on the first overall score being greater than the second overall score, the first digital component for transmission (ACT 56). The method 50 can include transmitting, to a second computing device, the first digital component.

As set forth above, the method 50 can include receiving, from a first computing device via a network, a data structure that can include device configuration information (ACT 51). The data structure can include device configuration information about the first computing device. The configuration information can include a data file that can indicate which function calls can be made on the computing device. For example, the configuration information can indicate if the computing device is configured to play auditory signals such as those included in the action data structures. The configuration information can indicate the resources of the computing device. For example, the configuration information can indicate whether the computing device includes a display, voice (or other sound) input device, touch input device, or speaker output device. The configuration information can also include utilization information such as the processor utilization, memory utilization, battery status, power status, types of communications that can be initiated from the computing device, or bandwidth utilization. The configuration information can also include the current level of resources of the computing device or an inventory level associated with the computing device. As one example where the computing device is an internet connected refrigerator, the inventor can be the inventory of a specific food product.

In some implementations, the data structure can be received from the client computing device as a packetized audio signal. The audio signal can be recorded as an input audio signal at the computing device. The computing device can transmit the packetized input audio signal to the server. The input audio signal can also include a request and a trigger word. The NLP component can parse the input audio signal to identify the request and trigger word within the input audio signal.

The method 50 can include identifying a first digital component and a second digital component (ACT 52). The identification of the first and the second digital component can be responsive to the request from the first computing device. The first digital component can include a command corresponding to a type of function and the second digital component cannot have the command corresponding to the type of function. For example, when activated by a computing device, the first digital component can initiate a function call that causes the computing device to, for example, initiate a phone call or a conversation (e.g., session) with a service provider server. The command can cause the computing device to initiate other voice functions such as presenting audio output signals. In some implementations, the first and second digital components can be selected or identified by a content selector component. The content selector component can identify the first digital component and the second digital component based on the trigger word identified by the NLP component when paring the input audio signal. For example, the content selector component can receive the request(s) or the trigger keyword(s) and based on this information can select one or more digital components. The digital components can include sponsored items having subject matter that relates to subject matter of the request or of the trigger keyword. The content item can be selected by the content selector component via a real-time content selection process. In one example, the first digital component can be a computing device that initiates a session between a computing device and a service provider server. The second digital component can include a visual content item that is displayed on a screen of the computing device.

The method 50 can include determining a first document score and determining a second document score (ACT 53). The document scores can be based on the content of the online resource accessed by the first computing device. The document scores can be a function of one or more of its relevance to a current user interest (e.g., as determined by the relationship between the digital component and the request or trigger word of the input audio signal), relevance to a user type, relevance to a user, an offer per impression, an offer per user action (e.g., selection, conversion, etc.), a performance parameter of the digital component (e.g., selection rate, user rating, conversion rate, etc.), how the digital component performs (e.g., in terms of selection rate, conversion rate, etc.) on computing devices device configurations similar to the computing device. In some implementations, the second document score greater of the second digital component can be greater than the first document score of the first digital component.

The method 50 can include determining a first function score for the first digital component and a second function score for the second digital component (ACT 54). The first and second function scores can be based on the device configuration information that can indicate the types of functions that can be performed by the computing device. The function scores can be a function of performance parameters of the digital components (e.g., selection rates, user ratings, conversion rates, etc.) when the digital components are presented on computing devices that cannot perform the function type associated with the first digital component. In some implementations, the second function score can be less than the first function score.

The method 50 can include generating a first overall score for the first digital component and a second overall score for the second digital component (ACT 55). The overall scores can be generated by combining the document score with the function score for each of the digital components. The function score and the document score can be combined in an un-weighted or weighted manner. In some implementations, the overall score for each of the digital components can be selected as the larger of the function and document score for the respective digital component.

The method 50 can include selecting, based on the first overall score and the second overall score, the first digital component (ACT 56). In some implementations, the first digital component can be selected because the first digital component has an overall score that is larger than the overall score of the second digital component.

The method 50 can include transmitting, to a second computing device based on the device configuration information indicating the first computing device does not have the type of function, the first digital component (ACT 57). Determining that the overall score of the first digital component that has the command associated the type of function is greater than the overall score of the second digital component; the data processing system can determine to transmit the first digital component to a computing device. In some implementations, the first digital component is transmitted to a computing device that is configured to be capable to execute the command associated to the type of function, such as present an output audio signal, initiate a session, or display a video. In some implementations, the first digital component can be sent to the first computing device if the device configuration information sent from the first computing device indicates that the first computing device can execute the command. If the first computing device cannot execute the command, the data processing system can transmit the first digital component to a second computing device that can execute the command. For example, if the first digital component includes a video file and the first client computing device does not include a display, the digital component can be sent to the second client computing device, which can be coupled with a display.

In some implementations, the second computing device is selected from a plurality of candidate computing devices. The second computing device can be selected from the plurality of candidate devices by an interface management component. The interface management component can poll a plurality of interfaces associated with the first computing device to identify a first candidate interface and a second candidate interface. The different candidate interfaces can be associated with the first computing device because each of the interfaces can be linked to an account associated with the first computing device. The interface management component can receive, for each of the first candidate interface and the second candidate interface, data structures that can indicate a list of functions associated with each of the respective first candidate interface and the second candidate interface. The list of function can indicate which commands each of the candidate computing devices can perform. If the interface management component identifies a match between the type of function of the first digital component and a function in the list of functions that can be performed by the first candidate interface, the interface management component can select the first candidate interface. The interface management component can then transmit the first digital component to the first candidate interface, which can be an interface of the second computing device. If the type of function matches to commands that both the candidate devices can perform, the interface management can select which of the candidate interface to transmit the first digital component based on at least one of a battery status, a processor utilization, a memory utilization, an interface parameter, or a bandwidth utilization of each of the candidate interfaces.

In some implementations, the method 50 can include generating at least one action data structure. For example, the direct action API can generate action data structures based on the requests or trigger keywords. The action data structures can indicate organic or non-sponsored content related to the input audio signal. The action data structure can be transmitted to the second computing device with the first digital component. In some implementations, the action data structure can be transmitted to the first computing device.

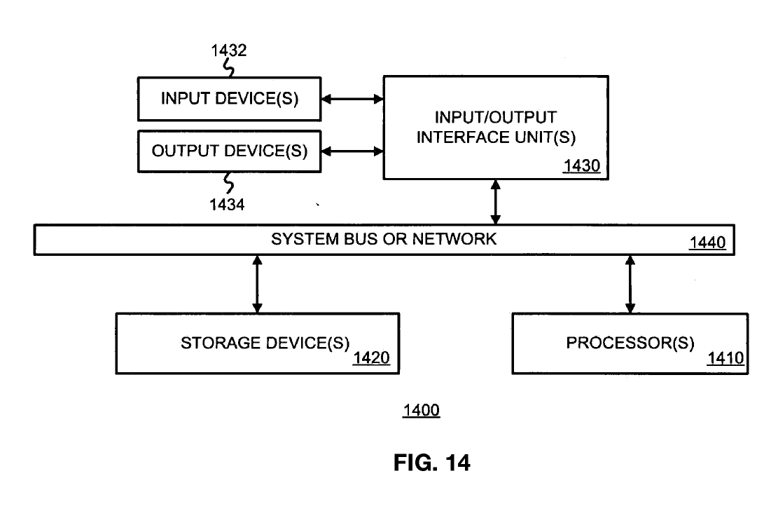

FIG. 14 is high-level block diagram of a machine 1400 that may perform one or more of the operations discussed above. The machine 1400 includes one or more processors 1410, one or more input/output interface units 1430, one or more storage devices 1420, and one or more system buses and/or networks 1440 for facilitating the communication of information among the coupled elements. One or more input devices 1432 and one or more output devices 1434 may be coupled with the one or more input/output interfaces 1430.

The one or more processors 1410 may execute machine-executable instructions (e.g., C or C++ running on the Solaris operating system available from Sun Microsystems Inc. of Palo Alto, Calif., the Linux operating system widely available from a number of vendors such as Red Hat, Inc. of Durham, N.C., the BREW or J2ME applications platforms, the Symbian operating system from Symbian of London, UK, Java, assembly, Perl, etc.) to effect one or more aspects of the present invention. At least a portion of the machine executable instructions may be stored (temporarily or more permanently) on the one or more storage devices 1420 and/or may be received from an external source via one or more input interface units 1430.

In one embodiment, the machine 1400 may be one or more conventional personal computers, mobile telephones, PDAs, etc. In the case of a conventional personal computer, the processing units 1410 may be one or more microprocessors. The bus 1440 may include a system bus. The storage devices 1420 may include system memory, such as reload only memory (ROM) and/or random access memory (RAM). The storage devices 1420 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1432, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1410 through an appropriate interface 1430 coupled to the system bus 1440. The output devices 1434 may include a monitor or other type of display device, which may also be connected to the system bus 1440 via an appropriate interface. In addition to (or instead of) the monitor, the personal computer may include other (peripheral) output devices (not shown), such as speakers and printers for example.

The machine 1400 may be a mobile telephone, mobile device, or any other computing device that can execute an assistant application.

In at least some embodiments consistent with the present invention, call-on-select digital components are only served and/or have selection enabled if the telephone number is a local telephone number. Such embodiments would avoid long distance calls. This feature may be linked with a calling plan of the user device.

Not all digital component links need to have telephone numbers associated with them. In at least some embodiments consistent with the present invention, the user is given an option (either before or after digital component selection) of making a voice call or going to the Web page. As shown in FIGS. 10 and 12 above, separate buttons with separate links for Web page display or voice calls can be provided. Alternatively, the service provider can decide this. As yet another alternative, whether to display a Web page or make a voice call may be determined by pre-existing user preferences.

To avoid user confusion, at least some embodiments consistent with the present invention may enforce the use of a consistent user interface across all ads. The service provider may be forced to have their digital components conform to such a consistent format when entering digital components into the digital component system or a format conversion from a non-compliant format to the consistent format may occur later.

The service provider can choose to offer different amounts for document (e.g., Web page) load-on-selection and call-on-selection. Performance parameters for each can be tracked separately.

The telephone number can be included as data and sent in variety of forms. It does not even need to be interpreted by standard HTML browsers. It can be sent as meta data in the header of the page returned. Alternatively, or in addition, it can be sent as comments with the each digital component. Alternatively, or in addition, it can be sent as structured data. Alternatively, or in addition, it can be sent as a “tel:XXX” tag. The first and second options are useful in cases in which the renderer is not known or under control of the server (for example if it is shown in a browser that does not support tel links). In such cases the telephone call functionality may not exist and the phone number will simply be ignored. The third option is useful if a structured feed is returned to the user device. For example, search results may be returned to a mobile telephone in a XML formatted feed. Digital components and all the related digital component fields can also be formatted in XML (or any other structured language). The XML is treated as a data feed and the rendering is all dictated by the intelligence built into a client application on the user device.

In at least some embodiments consistent with the present invention, the call-on-select telephone number may connect the client to an audio document (e.g., a voice message) or a live operator, depending on the telephone number specified by the service provider. Although not shown in FIGS. 8-12, different buttons can be used to indicate whether the call will be placed to an audio document or a live operator.

In at least some embodiments consistent with the invention, selecting a digital component or a button on a digital component may initiate both a call and a document-load. The call initiation and document-load initiation may occur in parallel or in series. In still another alternative embodiment consistent with the present invention, a limited document (e.g., in terms of time to load and render) with one or more call-on-select links can be loaded in response to a digital component selection. For example, rather than load a large Web page, a limited document stating:
CLICK HERE TO SPEAK WITH A TRAVEL AGENT
CLICK HERE TO HEAR ABOUT SPECIAL PROMOTIONS
may be loaded.

Although some of the exemplary embodiments described the use of a browser, at least some embodiments consistent with the present invention may use some other content rendering application or device.

The following examples illustrate the utility of an exemplary embodiment of the present invention. In a first example, assume that there are five digital components with at least the following information:

DIGITAL COMPONENT 1: landing page:
www.fareasttaste.com
offer-per-selection_{doc} : $0.10
selection rate_{doc} : 0.05
call-on-select number: NONE
offer-per-selection_{call}: NONE
selection rate_{call}: NONE
DIGITAL COMPONENT 2: landing page:
www.siamgarden.com
offer-per-selection_{doc} : $0.05
selection rate_{doc} : 0.05
•call-on-select number: 1-234-567-8910
offer-per-selection_{call}: $0.25
selection rate_{call}: 0.15
DIGITAL COMPONENT 3: landing page:
www.noodles.com
offer-per-selection_{doc} : $0.50
selection rate_{doc} : 0.12
call-on-select number: 1-234-109-8765
offer-per-selection_{call}: $0.30
selection rate_{call}: 0.20
DIGITAL COMPONENT 4: landing page: NONE
offer-per-selection_{doc} : NONE
selection rate_{doc} : NONE
call-on-select number: 1-234-789-1011
offer-per-selection_{call} $0.50
selection rate_{call}: 0.13
DIGITAL COMPONENT 5: landing page: NONE
offer-per-selection_{doc} : NONE
selection rate_{doc} : NONE
call-on-select number: 1-234-111-2222
offer-per-selection_{call}: $0.05
selection rate_{call}: 0.05

Assume further that a digital component score is the product of offer per selection and selection rate. Finally, assume that if the user device requesting the digital component has a limited display, that the score_{doc} is reduced by a factor of 20 (based on an assumption that the selection rate for selecting a digital component with a linked document is much less on a device with a limited display than on a device with a normal display).

Assume, now that DIGITAL COMPONENT 1 through DIGITAL COMPONENT 5 are eligible for a first request from a personal computer (normal display assumed) without call functionality. The digital components may be scored and ranked as shown in TABLE I.

TABLE I

| | | SELECTION | | |
|---|---|---|---|---|
| AD | OFFER_{DOC} | RATE_{DOC} | SCORE | RANK |
| DIGITAL | $0.10 | 0.05 | 0.0050 | 2 |
| COMPONENT 1 | | | | |
| DIGITAL | $0.05 | 0.05 | 0.0025 | 3 |
| COMPONENT 2 | | | | |
| DIGITAL | $0.50 | 0.12 | 0.0600 | 1 |
| COMPONENT 3 | | | | |
| DIGITAL | NONE | NONE | NONE | |
| COMPONENT 4 | | | | |
| DIGITAL | NONE | NONE | NONE | |
| COMPONENT 5 | | | | |

Notice that since DIGITAL COMPONENT 4 and DIGITAL COMPONENT 5 don't have linked documents and since the requesting user device doesn't have call functionality, otherwise eligible digital components aren't scored (or are given a default score of 0.0000 for example). In some embodiments, such digital components aren't served to avoid user confusion and frustration and so that a user's attention isn't taken away from DIGITAL COMPONENT 1 through DIGITAL COMPONENT 3.

Assume now that DIGITAL COMPONENT 1 through DIGITAL COMPONENT 5 are eligible for a second request from a mobile telephone (limited display) with support for call-on-select functionality. The digital components may be scored and ranked as shown in TABLE II.

TABLE II

| | OFFE | SELECTION | | | SELECTION | |
|---|---|---|---|---|---|---|
| AD | R_{DOC} | RATE_{DOC} | SCORE_{DOC} | OFFER_{CALL} | RATE_{CALL} | SCORE_{CALL} |
| digital | $0.10 | 0.05 | 0.000250 | NONE | NONE | NONE |
| component 1 | | | | | | |
| digital | $0.05 | 0.05 | 0.000125 | $0.25 | 0.15 | 0.0375 |
| component 2 | | | | | | |
| digital | $0.50 | 0.12 | 0.003000 | $0.30 | 0.20 | 0.0600 |
| component 3 | | | | | | |
| digital | NONE | NONE | NONE | $0.50 | 0.13 | 0.0650 |
| component 4 | | | | | | |
| digital | NONE | NONE | NONE | $0.05 | 0.05 | 0.0025 |
| component 5 | | | | | | |

An overall score may be a function of one or both of the score_{doc} and score_{call}. For example, an overall score may be MAX{score_{doc}, score_{call}}. Alternatively, an overall score may be score_{doc}+score_{call}. Assume, for this example, that the overall score is the maximum of the score_{doc} and score_{call}. The rank of the ads, from highest to lowest, would be DIGITAL COMPONENT 4, DIGITAL COMPONENT 3, DIGITAL COMPONENT 2, DIGITAL COMPONENT 5. Notice that even if DIGITAL COMPONENT 3 didn't have a call-on-select offer and functionality, its document score would still have been better than the call score of DIGITAL COMPONENT 5.

Finally, assume now that DIGITAL COMPONENT 1 through DIGITAL COMPONENT 5 are eligible for a third request from a laptop computer (normal display assumed) with support for call-on-select functionality. The digital components may be scored and ranked as shown in TABLE III.

TABLE III

| | | SELECTION | | | SELECTION | |
|---|---|---|---|---|---|---|
| AD | OFFER_{DOC} | RATE_{DOC} | SCORE_{DOC} | OFFER_{CALL} | RATE_{CALL} | SCORE_{CALL} |
| digital | $0.10 | 0.05 | 0.0050 | NONE | NONE | NONE |
| component 1 | | | | | | |
| digital | $0.05 | 0.05 | 0.0025 | $0.25 | 0.15 | 0.0375 |
| component 2 | | | | | | |
| digital | $0.50 | 0.12 | 0.0120 | $0.30 | 0.20 | 0.0600 |
| component 3 | | | | | | |
| digital | NONE | NONE | NONE | $0.50 | 0.13 | 0.0650 |
| component 4 | | | | | | |
| DIGITAL | NONE | NONE | NONE | $0.05 | 0.05 | 0.0025 |
| COMPONENT 5 | | | | | | |

Notice that in this case, since the user device has a full display, the document scores are not reduced. The final ranking may depend on how the overall score is determined using one or both of the score_{doc} and score_{call}. For example, these scores may be combined in a un-weighted or weighted manner (e.g., as specified by the service provider, as specified by the digital component serving system, and/or accounting for user behavior with respect to call-on-select and document-load-on-select ads).

### CONCLUSIONS

As can be appreciated from the foregoing, the present invention permits a server to better monetize searches and document requests, such as those on devices like mobile telephones that support call-on-select functionality, while permitting the avoidance of poor user experiences on such devices such as those due to small displays on such devices, slow communications connections and/or processors on such devices, and/or limits of user input on such devices. Further, in the same way that cost-per-selection yields higher offers and revenues than cost-per-impression, cost-per-call may yield higher offers and revenues than cost-per-selection (with a digital component landing Web page being loaded upon selection) since the service provider can talk directly with a potential customer.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1.-20. (canceled)

21. A system for device configuration-based function delivery, comprising:
a server comprising one or more processors and a memory to:
receive, from a first computing device via a network, a data structure including device configuration information;
identify, responsive to a request from the first computing device that accessed an online resource having content, a first digital component having a command corresponding to a type of function and a second digital component without the command corresponding to the type of function;
determine, based on the content of the online resource accessed by the first computing device, a first document score for the first digital component and a second document score for the second digital component, the second document score greater than the first document score;
determine, based on the device configuration information that indicates the type of function of the first computing device, a first function score for the first digital component having the command and a second function score for the second digital component item without the command, the second function score less than the first function score;
combine the first document score with the first function score to generate a first overall score for the first digital component; combine the second document score with the second function score to generate a second overall score for the second digital component, the second overall score less than the first overall score;
select, based on the first overall score being greater than the second overall score, the first digital component with the command corresponding to the type of function for transmission, via the computer network; and
transmit, to a second computing device based on the device configuration information indicating the first computing device does not have the type of function, the first digital component.

22. The system of claim 21, comprising:
the server configured to transmit, to the first computing device, the second digital component.

23. The system of claim 21, comprising a natural language processor component to:
receive, via an interface, data packets comprising an input audio signal detected by a sensor of the computing device; and
parse the input audio signal to identify the request and a trigger word.

24. The system of claim 23, comprising:
a content selector component to identify the first digital component and the second digital component response to the trigger word.

25. The system of claim 23, comprising a direct action application programming interface to:
generate, based on the request and the trigger word, a first action data structure; and
provide the first action data structure to the second computing device.

26. The system of claim 21, comprising an interface management component to:
poll a plurality of interfaces associated with the first computing device to identify a first candidate interface and a second candidate interface;
receive for each of the first candidate interface and the second candidate interface a second data structure indicating a list of functions associated with each of the respective first candidate interface and the second candidate interface;
determine the type of function matches a function in the list of functions associated with the first candidate interface; and
transmit the first digital component to the first candidate interface, the first candidate interface being an interface of the second computing device.

27. The system of claim 26, comprising:
the interface management to select which of the plurality of interfaces associated with the first component to poll based on at least one of a battery status, a processor utilization, a memory utilization, an interface parameter, or a bandwidth utilization of each of the plurality of interfaces.

28. The system of claim 21, comprising:
the server configured to transmit the first digital component to the second computing device to cause the command to access the type of function of the second computing device responsive to selection of the first digital component.

29. The system of claim 21, wherein the command is configured, upon activation, to cause the second computing device to initiate a voice function of the second computing device.

30. The system of claim 26, comprising:
the interface management to determine that the first candidate interface is linked to a first account and the second candidate interface is linked to the first account.

31. A configuration-based function delivery method comprising:
receiving, from a first computing device via a network, a data structure including device configuration information;
identifying, responsive to a request from the first computing device that accessed an online resource having content, a first digital component having a command corresponding to a type of function and a second digital component without the command corresponding to the type of function;
determining, based on the content of the online resource accessed by the first computing device, a first document score for the first digital component and a second document score for the second digital component, the second document score greater than the first document score;
determining, based on the device configuration information that indicates the type of function of the first computing device, a first function score for the first digital component having the command and a second function score for the second digital component item without the command, the second function score less than the first function score;
combining the first document score with the first function score to generate a first overall score for the first digital component; combining the second document score with the second function score to generate a second overall score for the second digital component, the second overall score less than the first overall score;
selecting, based on the first overall score being greater than the second overall score, the first digital component with the command corresponding to the type of function for transmission, via the computer network; and
transmitting, to a second computing device based on the device configuration information indicating the first computing device does not have the type of function, the first digital component.

32. The method of claim 31, comprising:
transmitting, to the first computing device, the second digital component.

33. The method of claim 31, comprising:
receiving, via an interface, data packets comprising an input audio signal detected by a sensor of the computing device; and
parsing, by a natural language processor component, the input audio signal to identify the request and a trigger word.

34. The method of claim 33, comprising:
identifying, by a content selector component, the first digital component and the second digital component response to the trigger word.

35. The method of claim 33, comprising:
generating, by a direct action application programming interface and based on the request and the trigger word, a first action data structure; and
providing the first action data structure to the second computing device.

36. The method of claim 31, comprising:
polling, by an interface management component, a plurality of interfaces associated with the first computing device to identify a first candidate interface and a second candidate interface;
receiving for each of the first candidate interface and the second candidate interface a second data structure indicating a list of functions associated with each of the respective first candidate interface and the second candidate interface;
determining the type of function matches a function in the list of functions associated with the first candidate interface; and
transmitting the first digital component to the first candidate interface, the first candidate interface being an interface of the second computing device.

37. The method of claim 36, comprising:
selecting, by the interface management, which of the plurality of interfaces associated with the first component to poll based on at least one of a battery status, a processor utilization, a memory utilization, an interface parameter, or a bandwidth utilization of each of the plurality of interfaces.

38. The method of claim 31, comprising:
transmitting, by the server, the first digital component to the second computing device to cause the command to access the type of function of the second computing device responsive to selection of the first digital component.

39. The method of claim 31, wherein the command is configured, upon activation, to cause the second computing device to initiate a voice function of the second computing device.

40. The method of claim 36, comprising:
determining, by the interface management, that the first candidate interface is linked to a first account and the second candidate interface is linked to the first account.
